(19) United States
(12) Patent Application Publication
(10) Pub. No.: US 2009/0309022 A1
(43) Pub. Date: Dec. 17, 2009

(54) APPARATUS FOR INSPECTING A SUBSTRATE, A METHOD OF INSPECTING A SUBSTRATE, A SCANNING ELECTRON MICROSCOPE, AND A METHOD OF PRODUCING AN IMAGE USING A SCANNING ELECTRON MICROSCOPE

(75) Inventors: Yasuhiro GUNJI, Hitachiota (JP); Akira Fujii, Mito (JP); Hiroyuki Takahashi, Hitachinaka (JP); Ryuichi Funatsu, Hitachinaka (JP); Toshifumi Honda, Yokohama (JP); Takashi Hiroi, Yokohama (JP); Hiroshi Makino, Kokubunji (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/480,443

(22) Filed: Jun. 8, 2009

(30) Foreign Application Priority Data
Jun. 12, 2008 (JP) 2008-153638
Sep. 19, 2008 (JP) 2008-240190

(51) Int. Cl. G01N 23/00; H01J 3/14

(52) U.S. Cl. 250/307; 250/311; 250/396 R

(57) ABSTRACT

An object of the present invention provides an inspection apparatus and an inspection method which use an electron beam image to accurately detect a defect that is difficult to detect in an optical image, the apparatus and method also enabling prevention of a possible decrease in focus accuracy of an inspection image which affect the defect detection. To accomplish the object, the present invention includes a height measurement section which measures height of the electron beam irradiation position on the substrate after the substrate is loaded onto a movable stage, a height correction processing section which corrects the measured height, and a control section which adjusts a focus of the electron beam according to the height corrected by the height correction processing section, wherein a stage position set when the height measurement section measures the height differs from a stage position set when the substrate is irradiated with the electron beam, and the height correction processing section corrects a possible deviation in height resulting from movement from the stage position for the height measurement to the stage position for the electron beam irradiation.

### FIELD OF THE INVENTION

The present invention relates to an apparatus for inspecting a substrate, a method of inspecting a substrate, a scanning electron microscope, and a method of producing an image using a scanning electron microscope, and for example, to an inspection apparatus including a scanning electron microscope allowing inspection of a semiconductor device, a substrate, a photo mask, an exposure mask, a reticle, a liquid crystal, and the like, which have a fine pattern, as well as an inspection method using the inspection apparatus. In particular, the present invention relates to a scanning electron microscope (hereinafter referred to as SEM) that irradiates a semiconductor being manufactured during a semiconductor preprocess, with a convergent electron beam to detect electrons emitted from the irradiation position, thus producing an image of the observation target. Examples of the apparatus include an SEM-type inspection apparatus for a semiconductor substrate for which a high-magnification image needs to be produced, an SEM-type dimension measuring apparatus for semiconductor patterns, and an SEM-type review apparatus that allows a defect detected in the semiconductor substrate to be observed in further detail and which allows further detailed inspections to be achieved based on the defect output by the inspection apparatuses.

### BACKGROUND OF THE INVENTION

Semiconductor devices such as memories and microcomputers used in computers and the like are manufactured by repeating a step of transferring a circuit pattern on a photo mask, an exposure mask, a reticle, or the like by means of an exposure process, a lithography process, an etching process, or the like. In the process of manufacturing semiconductor devices, the manufacturing yield of the semiconductor devices is seriously affected by the acceptability of the result of the lithography process, the etching process, or any other process and the presence of a defect such as foreign matter. Thus, the circuit pattern on the semiconductor substrate is inspected at the end of each manufacturing step in order to sense an error or a defect early or beforehand.

Increasingly miniaturized semiconductors have made the control of the semiconductor manufacturing preprocess increasingly difficult. In the semiconductor exposure step, with a node of size at most 45 nm, a defect of size at most 25 nm may cause an electric defect. Thus, an image of the surface of the semiconductor substrate needs to be produced at a very high definition resolution to allow a possible improper appearance to be detected or to allow a pattern width to be measured. In connection with this purpose, inspections, reviews, and pattern length measurements using SEMs have been increasingly important instead of conventional, optical visual inspections and length measurements. Apparatuses provided with SEMs irradiate an inspection target with an electron beam and collect secondary electrons or reflected electrons emitted by the inspection target to form an image. The apparatuses can thus provide higher-resolution images than the optical type. Furthermore, the number of detected secondary electrons varies depending on the potential of the inspection target. This enables the electrical characteristics of the image production target to be visualized.

To achieve accurate, high-throughput inspections in association with an increase in size of a substrate such as a semiconductor substrate and a miniaturized circuit pattern, an image with a high SN ratio needs to be acquired at a very high speed. Thus, a beam with a large current (for example, at least 100 nA) is used which is at least 1,000 times as large as that for normal scanning electron microscopes. Then, the semiconductor substrate is irradiated with an appropriate number of electrons, with a high SN ratio maintained. Moreover, in order to acquire an image with a high SN ratio, it is essential to quickly and efficiently detect secondary electrons and reflected electrons from the substrate.

The document “Handbook of Electrons and Ion Beams, Second Edition (particularly pp. 622-623) (edited by 132nd Committee of Japan Society for the Promotion of Science, THE NIKKAN KOGYO SHIMBUN, LTD, 1986) describes that a semiconductor substrate with an insulating film such as a resist is irradiated with an electron beam at a low acceleration of at most 2 keV so as to be prevented from being affected by charging. However, with a large-current and low-acceleration electron beam, aberration may result from a space charge effect, preventing high-resolution images from being easily obtained.

As a method for solving this problem, a technique is known which decelerates a high-acceleration electron beam immediately in front of a substrate to irradiate the substrate with a substantially low-acceleration electron beam as disclosed in, for example, JP Patent Publication (Kokai) Nos. 02-142045A1 (1990) and 06-139985A1 (1994).

On the surface of the semiconductor substrate, the work distance between an SEM and an image production target is varied by the possible warpage of the semiconductor substrate per se. Thus, without appropriate measures, the best focus of primary electrons cannot be achieved on the image production target. Thus, JP Patent Publication (Kokai) No. 11-149895A1 (1999) describes a technique of using a height measuring instrument to determine the height of the surface of the substrate and setting the focus of the SEM according to the height position.

The SN ratio of a produced image depends significantly on the product of the number of primary electrons with which the target is irradiated and the area of the image production target. Thus, to obtain an image with a high SN ratio in a short time, the number of primary electrons, that is, the magnitude of a probe current, needs to be increased. However, this causes the image production target to emit a large number of secondary electrons in a short time. Thus, the surface of the substrate is positively charged. This causes the trajectory of the secondary electros emitted from the surface of the substrate to be bent or prevents the electrical characteristics of the image production target from being visualized.

JP Patent No. 3730263 describes a technique of installing a lower lens pole piece allowing a change in a voltage relative to the substrate, inside an SEM at a position closest to a substrate, in order to prevent the above-described problems. Controlling the intensity of the lower lens pole piece allows only some of the secondary electrons generated on the surface of the substrate to be guided to a detector of the SEM; these secondary electrons have energy exceeding a potential generated by electric fields formed by the substrate and an electrode provided on the substrate. The other electrons are returned to the substrate. This allows the charging potential of the substrate to be controlled.

The two conventional techniques described in JP Patent Publication (Kokai) No. 11-149895A1 (1999) and JP Patent No. 3730263 described above may be combined together. The combination enables the construction of an SEM-type inspection apparatus and an SEM-type measuring apparatus which can bring the SEM into focus without being affected by the warpage of the substrate and control charging on the substrate.

Moreover, JP Patent Publication (Kokai) No. 2007-317467A1 discloses a technique of irradiating a substrate with a plurality of electron beams at the same time to independently detect the respective beam spots, in order to quickly produce a high-resolution SEM image. According to JP Patent Publication (Kokai) No. 2007-317467A1, a surface field control electrode is provided at a location in an electronic optical system which is closest to the substrate, so as to achieve the same objective as that of the lower lens pole piece described in JP Patent Publication (Kokai) No. 11-149895A1 (1999). A hole is formed in the surface field control electrode so as to allow light for height measurement to pass through.

### SUMMARY OF THE INVENTION

The inspection apparatuses utilizing SEMs as disclosed in JP Patent Publication (Kokai) Nos. 02-142045A1 (1990) and 06-139985A1 (1994) described above, unlike the optical type, use an irradiation beam and peripheral fields to charge a defect on the substrate. Thus, a potential contrast is applied to the defect, which can then be detected.

However, in this case, a charging control electrode or the like is located in the vicinity of the beam irradiation in order to control the charging. This disadvantageously prevents an appropriate working distance from being ensured, thus hindering, for example, real-time height measurement during beam irradiation for inspection. This means that for a substrate mounted on a movable stage, the height needs to be measured at a stage position different from that during the inspection. Thus, regardless of the type of the height measuring method, the focus accuracy of inspection images may be reduced. As a result, defect detecting capability may be degraded.

The present invention has been made in view of the above-described circumstances. An object of the present invention is to provide an inspection apparatus and an inspection method which allow a defect difficult to detect in an optical image to be accurately detected using an electron beam image, the method and apparatus further preventing a possible decrease in the focus accuracy of the inspection image, which disadvantageously hinders defect detection.

Furthermore, the recent miniaturized inspection and measurement targets require an SEM that can produce images at a higher resolution. To meet this requirement, the diameter of a primary electron beam converged on the surface of the substrate, that is, the beam diameter, needs to be minimized.

However, the beam diameter is disadvantageously increased when the potential of the lower lens pole piece configured as described in JP Patent Publication (Kokai) No. 11-149895A1 (1999), described above, or of the surface field control electrode described in JP Patent Publication (Kokai) No. 2007-317467A1, described above, is set equivalent to or lower than that of the substrate, so as to prevent the positive charging of the substrate. The effects of the lower lens pole piece are almost the same as those of the surface field control electrode. Thus, the lower lens pole piece and the surface field control electrode are hereinafter collectively referred to as the surface field control electrode.

The speed of electrons in the trajectory of the electrons is closely related to, for example, a possible aberration in the SEM such as a diffractive aberration or a chromatic aberration and the spread of electrons caused by the Coulomb's force generated by the mutual repulsion of the electrons; the spread of electrons poses a problem when the primary electron beam carries a large current. Thus, the electrons need to be applied to the image production target as fast as possible.

However, when the potential of the surface field control electrode is set equivalent to or lower than that of the substrate, the flying speed of the electrons decreases rapidly to increase the beam diameter.

Moreover, in the example described in JP Patent Publication (Kokai) No. 2007-317467A1, described above, setting the potential of the surface field control electrode almost the same as that of the substrate or to a negative value prevents primary electrons applied to a plurality of locations from being separately detected.

To minimize the increase in beam diameter, the surface field control electrode needs to be located as close to the substrate as possible to minimize the area in which electrons fly at a low speed. In actuality, JP Patent Publication (Kokai) No. 2007-317467A1, described above, describes that the distance between the surface field control electrode and the substrate is reduced down to 300 μm. However, this configuration disadvantageously increases the diameter of the electron beam.

In general, a semi-in-lens type electron lens that generates intense magnetic fields reaching the substrate surface can be effectively used to reduce the beam diameter. However, the semi-in-lens type electron lens allows intense magnetic fields to leak to below an objective lens. This prevents the compact design of a magnetic path through which the magnetic field travels. Thus, even if a hole is created in the surface field control electrode to form an optical path for height detection, reducing the beam diameter is difficult because the hole open at a position on the magnetic path and close to the substrate may increase the level of the possible aberration in the objective lens.

Furthermore, when an optical path is set at a location on the surface field control electrode which is close to the optical axis of the beam, the uniformity of electric fields is degraded. This disadvantageously increases the level of the possible aberration. This problem is particularly serious if the substrate is irradiated with slit light for a height detector.

A large opening is required to allow the substrate to be irradiated with the slit light for the height detector. This significantly degrades the uniformity of the electric fields. For example, if the height of the substrate varies by ±40 μm and the substrate is irradiated with slit light with a length of 1 mm at an incident angle of 80° to the normal of the substrate, two openings each of which is larger than 1 mm×500 μm at minimum need to be formed close to the optical axis. This makes the control of surface fields difficult.

On the other hand, when the height is detected using one beam of spot light, an error corresponding to the half of the beam diameter results from the reflectance of the target exhibited at the spot irradiation position. Thus, the height measurement using one beam spot is inappropriate for accurate and stable inspections and measurements. Slit light, desirably a plurality of beams of slit light, needs to be used for the height measurement. However, as described above, it is disadvantageously difficult to provide the required large opening and produce SEM images at a high resolution at the same time. An object of the present invention is to provide a scanning electron microscope that allows the height of the substrate to be detected with the surface field control electrode located in proximity to the substrate, to enable focusing, thus allowing high-quality SEM images to be produced. The present invention also provides a method of focusing the scanning electron microscope.

To accomplish this object, the present invention provides an apparatus for inspecting a substrate, the apparatus indicating the substrate with an electron beam to inspect the substrate for a defect based on an image produced based on a secondary electron or a reflected electron generated on the substrate. More specifically, the apparatus comprises a height measuring section which measures height of an electron beam irradiation position on the substrate after the substrate is loaded onto a movable stage, a height correction processing section which corrects the measured height, and a control section which adjusts a focus of the electron beam according to the height corrected by the height correction processing section. Here, even with the position on the substrate unchanged, a stage position (a coordinate on the stage) set when the height measuring section measures the height differs from a stage position (a coordinate on the stage) set when the substrate is irradiated with the electron beam. The height correction processing section corrects a possible deviation in height resulting from movement from the stage position for the height measurement to the stage position for the electron beam irradiation. The inclination of the stage may cause the possible deviation in height resulting from movement from the stage position for the height measurement to the stage position for the electron beam irradiation. The height measuring section is composed of a reflected light-type measuring instrument or a combination of a laser interferometer-type shape measuring instrument and an electrostatic capacitance-type displacement meter.

The defect inspection for the substrate is performed by continuously moving the stage. The height correction processing section corrects the height every time the stage is moved.

The apparatus for inspecting the substrate further comprises a charging control electrode located in vicinity of a substrate position for the electron beam irradiation to control charging of the substrate. The charging control electrode makes the position of the height measurement (position on the stage) different from the position of the optical axis of the electron beam (position on the stage).

The height correction processing section executes the height correction as an online process during the substrate defect inspection or substrate image acquisition or as an offline process at a timing different from that for the substrate defect inspection or substrate image acquisition. For the offline process, the apparatus for inspecting the substrate further comprises a correction data storage section which stores correction data required for the stage movement from the stage position for the height measurement to the stage position for the electron beam irradiation. In this case, the height correction processing section corrects the measured height based on the correction data stored in the correction data storage section. The correction data can be displayed on a screen when the correction data is created or used. This allows the correction data to be checked.

Furthermore, to accomplish the above-described object, the apparatus according to the present invention includes a surface field control electrode, or a shield electrode located around a periphery of the surface field control electrode and at a height position from the substrate equivalent to that of the surface field control electrode, or an optical path for height measurement located between the two electrodes at at least a given distance from an optical axis of an electronic optical system so as to be point asymmetric with respect to the optical axis, and further includes a height measuring section which measures the substrate height using the optical path.

The apparatus further includes a memory section which holds the substrate height output by the height measuring section and a substrate position measuring section which measures the position of the substrate. This allows the focus position of an SEM to be controlled based on the previously measured height of a substrate surface on the optical axis of the electron beam. The apparatus further includes a mechanism which corrects amount of a deviation from a previous measurement result based on a previously measured substrate surface height and a substrate surface height measured in real time to control the focus position.

Further features of the present invention will be apparent from the best mode for carrying out the present invention described below and the accompanying drawings.

The present invention enables excellent substrate inspections to provide a very sensitive defect detecting capability even if the sufficient contrast of a defect site fails to be obtained owing to the characteristics of the substrate.

The present invention allows the height of the substrate to be detected, for focusing, with the surface field control electrode located in proximity to the substrate, thus enabling high-quality SEM images to be produced. In particular, the present invention allows a semiconductor substrate with a wiring width of at most 45 nm to be inspected and measured. Electric fields along the optical axis of the electronic optical system are prevented from being affected by the optical path for height measurement provided at at least the given distance from the optical axis of the electronic optical system so as to be point asymmetric with respect to the optical axis. Thus, the surface field control electrode can be located in proximity to the substrate.

### BRIEF DESCRIPTION OF THE DRAWINGS

FIG. 1 is a vertical sectional view showing the configuration of an SEM-type visual inspection apparatus.

FIG. 2 is a block diagram of functions including height measurement involving a correction process.

FIG. 3 is a diagram showing that a substrate is irradiated with an electron beam.

FIG. 4 is a diagram illustrating a correction process based on stage movement.

FIG. 5 is a diagram illustrating a method for preparing correction data.

FIG. 6 is a diagram illustrating a GUI used to create and reference correction data.

FIG. 7 is a diagram schematically showing the configuration of a laser interferometer-type shape measuring instrument.

FIG. 8 is a diagram schematically showing the configuration of an electrostatic capacitance-type displacement meter.

FIG. 9 is a diagram illustrating a height sensor composed of a combination of a laser interferometer-type shape measuring instrument and an electrostatic capacitance-type displacement meter.

FIG. 10 is a block diagram schematically showing the configuration of an SEM-type inspection apparatus.

FIG. 11 is a diagram showing an example of a surface field control electrode.

FIG. 12 is a diagram showing an example of a light pattern emitted onto the substrate.

FIG. 13 is a diagram illustrating an optical path in a height detector.

FIG. 14 is an enlarged view of a light pattern 1302 of slit light.

FIG. 15 is a diagram showing an example of a shield electrode in a first embodiment.

FIG. 16 is a diagram illustrating an inspection area and a focusing method.

FIG. 17 is a diagram illustrating a height estimating method.

FIG. 18 is a block diagram schematically showing the configuration of an SEM apparatus.

FIG. 19 is a diagram illustrating an image production area.

FIG. 20 is a block diagram schematically showing the configuration of the SEM apparatus.

FIG. 21 is a diagram illustrating the optical path in the height detector.

FIG. 22 is a sequence diagram of an SEM-type measuring apparatus.

FIG. 23 is a diagram showing an example of an initial height measuring position on the substrate.

FIG. 24 is a diagram illustrating an image production sequence in which an image of the substrate is produced with the stage moved on a step and repeat manner.

FIG. 25 is a diagram of the configuration of a system using an SEM.

### DETAILED DESCRIPTION OF THE PREFERRED EMBODIMENTS

Recent scanning electron microscopes (SEM) include electronic optical systems with complicated configurations so as to enable accurate observations. Thus, a position on a stage for the measurement of the height of a substrate may deviate from a position (optical axis) on the stage which is irradiated with an electron beam. The stage is inclined in spite of efforts to make the stage flat, though the inclination is very small (on the order of μm). Then, if the height measurement position on the stage differs from the electron beam irradiation position, accurate focusing is hindered even with the use of a measured height.

An object of the present invention is to enable accurate focus control even if the height measurement position differs, on a stage coordinate, from the electron beam irradiation position.

An embodiment of the present invention will be described below with reference to the accompanying drawings. However, it should be noted that the present embodiment is only an example in which the present invention is implemented and does not limit the technical scope of the present invention. Arrangements common to the drawings are denoted by the same reference numerals.

### (1) First Embodiment

### <Configuration of the Inspection Apparatus>

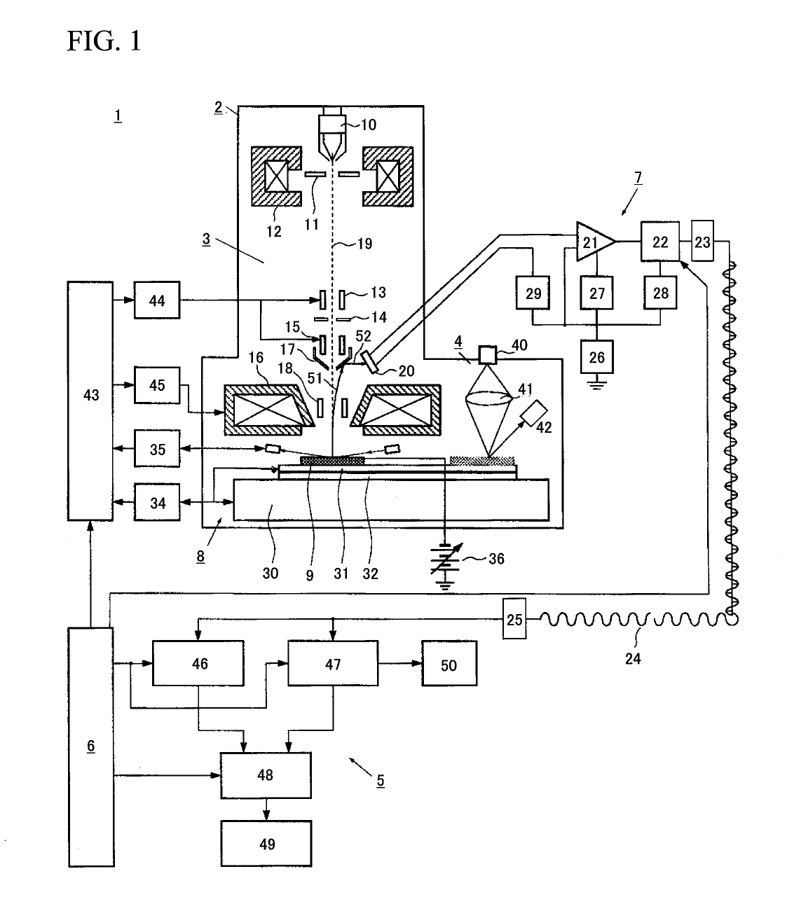

FIG. 1 is a vertical sectional view schematically showing the configuration of an SEM-type visual inspection apparatus 1 that is an example of an inspection apparatus using a scanning electron microscope to which the present invention is applied.

An SEM-type visual inspection apparatus 1 includes an inspection chamber 2 the interior of which is evacuated, a preliminary chamber (not shown in the present embodiment) from which a substrate 9 is conveyed into the inspection chamber 2, an image processing section 5, a control section 6, and a secondary electron detecting section 7. The preliminary chamber is configured to be able to be evacuated independently of the inspection chamber 2. Roughly speaking, an electronic optical system 3, a substrate chamber 8, and an optical microscope section 4 are provided in the inspection chamber 2.

The electronic optical system 3 is composed of an electron gun 10, an electron bean lead-out electrode 11, a condenser lens 12, a blanking polarizer 13, a scanning polarizer 15, a diaphragm 14, an objective lens 16, a reflector 17, and an ExB polarizer 18. A secondary electron detector 20 in the secondary electron detecting section 7 is located above the objective lens 16 in the inspection chamber 2. An output signal from the secondary electron detector 20 is amplified by a preamplifier 21 installed outside the inspection chamber 2. The amplified output signal is converted into digital data by an AD converter 22.

The substrate chamber 8 is composed of a substrate table 30, an X stage 31, a Y stage 32, a position monitor length measuring instrument 34, and an inspection target substrate height measuring instrument 35.

The optical microscope section 4 is installed in the vicinity of the electronic optical system 3 in the inspection chamber 2, at a known distance from the electronic optical system 3 such that the optical microscope section 4 and the electronic optical system 3 are prevented from affecting each other. An X stage 31 or a Y stage 32 reciprocates over the known distance between the electronic optical system 3 and the optical microscope section 4. The optical microscope section 4 includes a light source 40, an optical lens 41, and a CCD camera 42.

The image processing section 5 includes a first image storage section 46, a second image storage section 47, an arithmetic operation section 48, and a defect determining section 49. A captured electron beam image or optical image is shown on a display 50.

Operational instructions and conditions for the relevant sections of the apparatus are input to and output from the control section (which may be a computer such as a workstation) 6. The following conditions are pre-stored in the control section 6 so as to be able to be optionally or selectively set according to the objective: an acceleration voltage for generation of an electron beam, a polarization range for the electron beam, a polarization speed for the electron beam, a timing at which the secondary electron detecting device captures a signal, and a substrate table movement speed. The control section 6 uses a correction control circuit 43 to display a deviation in position or height based on signals from the position monitor length measuring instrument 34 and the inspection target substrate height measuring instrument 35. Based on the result, the control section 6 generates and sends a correction signal to an objective lens power source 45 and a scanning signal generator 44 so as to allow the electron beam to be emitted to the correct position with reliability.

To acquire an image of the inspection target substrate 9, the inspection target substrate 9 is irradiated with a narrowed electron beam 19 to generate a secondary electron 51. The secondary electron 51 is then detected in synchronism with scanning with the electron beam 19 and movement of the X stage 31 and the Y stage 32. Thus, an image of the inspection target substrate 9 is obtained.

It is essential that the SEM-type visual inspection apparatus offer a high inspection speed. This allows the omission of low-speed scanning with an electron beam with an electron beam current of the order of pA, a large number of scans, and superimposition of images as in the case of SEMs based on the ordinary, conventional schemes. Furthermore, to inhibit an insulating material from being charged, the electron beam scanning needs to be performed only once or several times at a high speed; a large number of scans need to be avoided. Thus, for a single scanning session, the present embodiment forms images using an electron beam with a large current that is at least about 1,000 times as large as that in the SEMs based on the conventional schemes, for example, 100 nA.

A diffusive refilling-type thermal field emitting electron source is used as the electron gun 10. The electron gun 10 can provide a stable electron beam current compared to conventional electron sources, for example, a tungsten filament electron source and a cold field emission-type electron source. Thus, electron beam images with a reduced variation in brightness can be obtained. The electron gun 10 also allows a large electron beam current to be set, thus enabling high-speed inspections as described below. The electron beam 19 is led out from the electron gun 10 by applying a voltage to between the electron gun 10 and the lead-out electrode 11.

The electron beam 19 is accelerated by applying a high-voltage negative potential to the electron gun 10. Thus, the electron beam 19 travels toward the substrate table 30 because of energy corresponding to the potential of the electron beam 19. The electron beam 19 is converged by the condenser lens 12, and then narrowed by the objective lens 16 and applied to the inspection target substrate 9 mounted on the X stage 31 and the Y stage 32. The inspection target substrate 9 may be a semiconductor substrate, a chip, or a substrate such as a liquid crystal or a mask which has a fine circuit pattern. A scanning signal generator 44 generating scanning signals and blanking signals is connected to the blanking polarizer 13. The objective lens power source 45 is connected to the objective lens 16. Although not shown in FIG. 1, a charging control electrode 212 is provided below the objective lens 16 in the vicinity of a position on the substrate which is irradiated with the electron beam as shown in FIG. 3 and other figures.

A negative voltage from a high voltage power source 36 can be applied to the inspection target substrate 9. Adjusting the voltage of the high voltage power source 36 allows the electron beam 19 to be decelerated. Thus, the irradiation energy of the electron beam to the inspection target substrate 9 can be adjusted to an optimum value without the need to change the potential of the electron gun 10.

The secondary electron 51 generated by irradiating the inspection target substrate 9 with the electron beam 19 is accelerated by a negative voltage applied to the inspection target substrate 9. The ExB polarizer 18 is located above the inspection target substrate 9 to bend the trajectory of the secondary electron with the trajectory of the electron beam 19 prevented from being affected by both electric and magnetic fields. Thus, the accelerated secondary electron 51 is polarized to a predetermined direction. The amount of the polarization can be adjusted based on the intensities of electric and magnetic fields applied to the ExB polarizer 18. The electric and magnetic fields can be varied in conjunction with the negative voltage applied to the inspection target substrate 9.

The secondary electron 51 polarized by the ExB polarizer 18 collides against the reflector 17 under predetermined conditions. The reflector 17 is conical and functions as a shield pipe that shields the electron beam 19 applied to the inspection target substrate 9. When the accelerated secondary electron 51 collides against the reflector 17, a second secondary electron 52 having energy of several eV to 50 eV is generated on the reflector 17.

For the secondary electron detecting section 7, a secondary electron detector 20 is provided in the evacuated inspection chamber 2. Furthermore, the following are provided outside the inspection chamber 2: a preamplifier 21, an AD converter 22, a light converting section 23, a light transmitting section 24, an electric converting section 25, a high voltage power source 26, a preamplifier driving power source 27, an AD converter driving power source 28, and a reverse bias power source 29. Thus, the secondary electron detecting section 7 is composed of the secondary electron detector 20, the preamplifier 21, the AD converter 22, the light converting section 23, the light transmitting section 24, the electric converting section 25, the high voltage power source 26, the preamplifier driving power source 27, the AD converter driving power source 28, and the reverse bias power source 29.

The secondary electron detector 20 in the secondary electron detecting section 7 is located above the objective lens 16 in the inspection chamber 2. The high voltage power source 26 floats the secondary electron detector 20, the preamplifier 21, the AD converter 22, a light converting section 23, a preamplifier driving power source 27, and an AD converter driving power source 28 to a positive potential. The second secondary electron 52 resulting from the collision against the reflector 17 is guided to the secondary electron detector 20 by an attraction field created by the positive potential.

The secondary electron detector 20 is configured to detect the second secondary electron 52 resulting from the secondary electron 51 colliding against the reflector 17, in conjunction with a timing for scanning with the electron beam 19. An output signal from the secondary electron detector 20 is amplified by the preamplifier 21, installed outside the inspection chamber 2. The amplified output signal is then converted into digital data by the AD converter 22.

The AD converter 22 is configured to convert an analog signal detected by the secondary electron detector 20 to a digital signal, immediately after the analog signal is amplified by the preamplifier 21, and then to transmit the converted signal to the image processing section 5. Immediately after the detection, the detected analog signal is digitalized and then transmitted. This can provide a signal which is faster and has a higher SN ratio than in the conventional art.

The inspection target substrate 9 is mounted on the X stage 31 and the Y stage 32. One of the following two methods can be selected: a method of performing two-dimensional scanning with the electron beam 19 with the X stage 31 and the Y stage 32 remaining stationary in an inspection time and a method of performing linear scanning in an X direction by continuously moving the X stage 31 and Y stage 32 in a Y direction at a constant speed in an inspection time. For inspection of a relatively small area, the former method is effective in which the inspection is carried out with the inspection target substrate 9 remaining stationary. On the other hand, for inspection of a relatively large area, the method is effective in which the inspection is carried out with the inspection target substrate 9 continuously moved at the constant speed. When the electron beam 19 needs to be blanked, the blanking polarizer 13 polarizes the electron beam 19 so as to controllably prevent the electron beam from passing through the diaphragm 14.

The present embodiment uses a length measuring instrument based on laser interference as the position monitor length measuring instrument 34, which displays the positions of the X stage 31 and the Y stage 32. The position monitor length measuring instrument 34 can display the positions of the X stage 31 and the Y stage 32 in real time and transfer the result to the control section 6. Data on, for example, the rotation numbers of motors for the X stage 31 and the Y stage 32 is also transferred from respective drivers to the control section 6. Based on the data, the control section 6 can accurately determine the area and position irradiated with the electron beam 19. Thus, the correction control circuit 43 can correct a possible deviation in the irradiation position of the electron beam 19 in real time as required. Furthermore, the area irradiated with the electron beam 19 can be stored for each inspection target substrate 9.

The inspection target substrate height measuring instrument 35 is an optical measuring instrument, for example, a laser interference measuring instrument or a reflected light-type measuring instrument that measures variation at the position of reflected light. The inspection target substrate height measuring instrument 35 is configured to be able to measure the height of the inspection target substrate 9 mounted on the X stage 31 and the Y stage 32, in real time. The present embodiment uses a scheme in which the inspection target substrate 9 is irradiated, through a transparent window, with elongate white light having passed through slits 53 and 54 so that the position of reflected light is detected by a position detecting monitor. In this case, the amount of variation in height is calculated from variation in position. Based on measurement data from the optical height measuring instrument 35, the focal distance of the objective lens 16 is dynamically corrected. This allows the electron beam 19 focused on the inspection target area to be constantly provided. Alternatively, the warpage or height distortion of the inspection target substrate 9 may be measured before the electron beam irradiation so that correction conditions for the objective lens 16 can be set for each inspection target area according to the resulting data.

The image processing section 5 is composed of a first image storage section 46, a second image storage section 47, an arithmetic operation section 48, a defect determining section 49, and a display 50. An image signal for the inspection target substrate 9 detected by the secondary electron detector 20 is amplified by the preamplifier 21. The amplified image signal is then digitalized by the AD converter 22. The digitalized signal is then converted into a light signal by the light converting section 23 and transmitted by the light transmitting section 24. The light signal is then converted again into an electric signal by an electric converting section 25. The converted signal is then stored in the first image storage section 46 or the second image storage section 47. The arithmetic operation section 48 aligns the image signal stored in the first image storage section 46 with the image signal stored in the second image storage section 47, normalizes the levels of the signals, and executes various image processing operations to remove noise signals. The arithmetic operation section 48 then compares and calculates the two image signals. The defect determining section 49 compares a predetermined threshold with the absolute value of a difference image signal resulting from the comparison and calculation in the arithmetic operation section 48. If the difference image signal level is greater than the predetermined threshold, the defect determining section 49 determines the corresponding pixel to be a suspected defect. The defect determining section 49 then displays the position and number of defects on the display 50.

### <Summary of a Height Correcting Process>

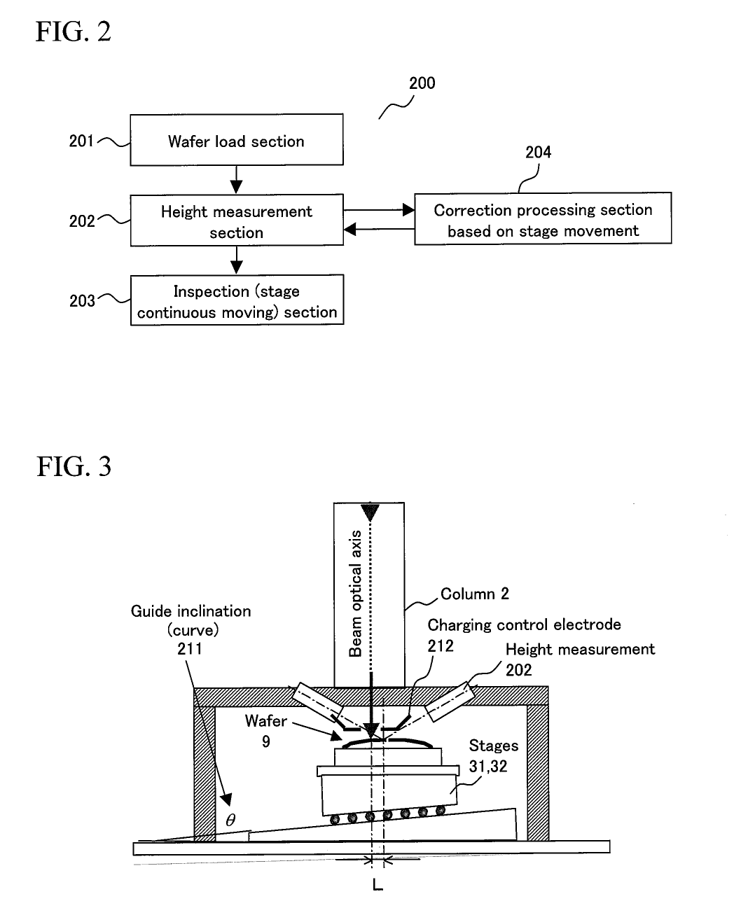

FIG. 2 is a function block diagram schematically showing a process of correcting information on the measured height which process is executed in a first embodiment of the present invention. First, a substrate load section 201 loads the substrate 9 with a circuit pattern formed on the surface thereof, onto the movable stage (see 31 and 32 in FIG. 3). Thereafter, a height measuring section 202 measures the height of the loaded substrate 9. An inspection section 203 allows an electron beam to repeatedly scan the substrate 9. The inspection section 203 then detects a defect portion in an image produced based on secondary electrons or reflected electrons generated on the substrate 9. The present invention is characterized in that the height measuring section 202 includes a correction processing section 204 moved on the stages 31 and 32. Here, the inspection section 203 may perform inspections with the stages 31 and 32 continuously moved. Furthermore, the height measuring section 202 is composed of the inspection target substrate height measuring instrument 35.

Now, the necessity of the height correction performed by the correction processing section 204 based on the stage movement will be described. FIG. 3 shows that the substrate 9 is irradiated with a beam. An SEM-type inspection apparatus charges a defect on the substrate 9 by means of an irradiation beam or a peripheral field to apply a potential contrast to the defect, which can thus be detected. In this case, a charging control electrode 212 is located in the vicinity of the position of the beam irradiation in order to control the charging on the substrate 9. This disadvantageously prevents an appropriate working distance from being ensured, thus hindering, for example, real-time height measurement or the like during beam irradiation (during inspection). That is, height measurement is forced to be performed on a position located at a distance L from the optical axis of the beam (the position remains unchanged on the substrate but is offset by L on the stage), as shown in FIG. 3. In this condition, an error corresponding to the inclination θ 211 of the stage guide occurs in the height measurement. Thus, regardless of the type of the height measuring method, the focus accuracy of an inspection image and thus the defect detecting capability may be degraded. To solve this problem, a correction process based on the stage movement is required.

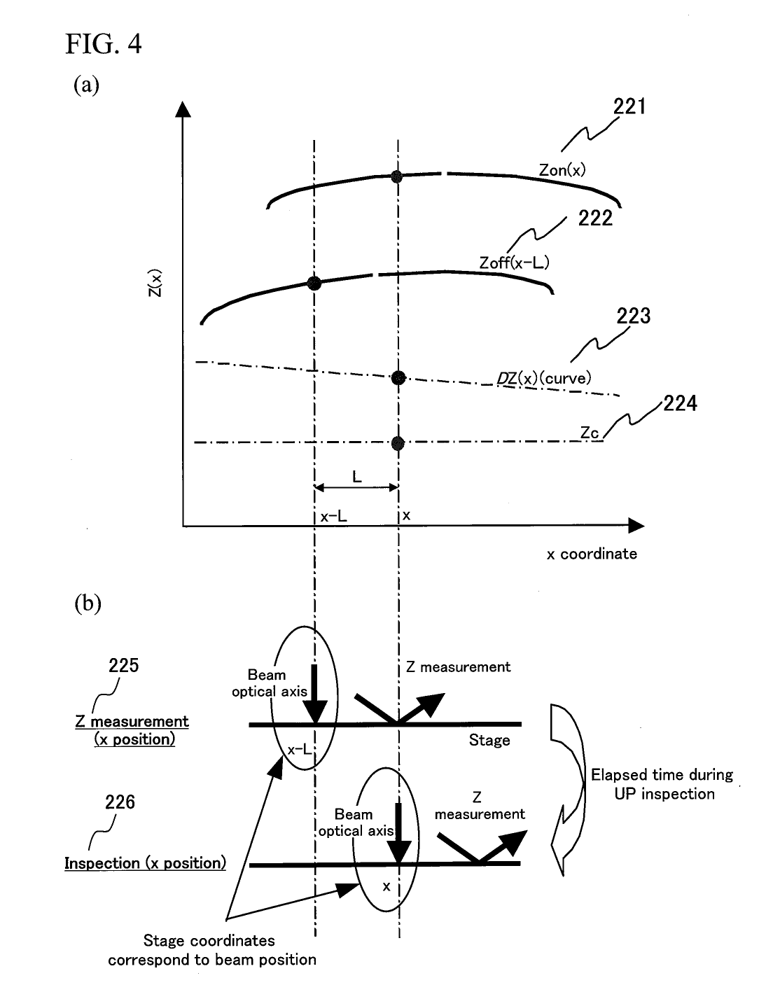

Now, the height correcting process executed by the correction processing section 204 based on the stage movement will be described with reference to FIG. 4. FIG. 4 shows the relationship between an actual substrate height Zon(x) 221 to be determined for a stage coordinate x and a measured value Zoff(x−L) 222 obtained when a height sensor is installed at the distance L from the beam optical axis as shown in FIG. 3. The relationship can be expressed by:

Zon(x)=Zoff(x−L)+DZ(x) (1)

Here, a guide inclination correction curve DZ(x)=Zon_opt(x)−Zoff(x−L), and Zon_opt(x) denotes the height of an optical focal position determined by image processing using a standard substrate and the like.

That is, the Zon(x) 221 to be determined corresponds to the sum of the Zoff(x−L) 222 to be measured and the guide inclination correction value DZ(x) 223. The guide inclination correction value DZ(x) 223 is a difference value and thus need not be measured using an actual substrate in real time. Thus, the difference between the height Zon_opt(x) of the optical focal position and the measured value Zoff(x−L) 222 can be determined offline using a standard substrate and the like beforehand. The DZ(x) 223 in FIG. 4(A) shows the distribution of the difference. The DZ(x) 223 is a component that corrects a possible error in the height measurement caused by the inclination θ 211 of the stage guide shown in FIG. 3. For example, the DZ(x) 223 is stored in a table and read and used for a height correcting process. Periodically calibrating the table value DZ(x) enables a more accurate height measurement and thus more accurate focus control.

FIG. 4(B) is a diagram showing the transition between two conditions in which the height measurement position (Z measurement position) is located at the distance L from the beam optical axis on the stage. A certain position of the beam optical axis corresponds to the inspection position. A coordinate indicating the position is a stage coordinate (in this case, an x coordinate). In the upper part of FIG. 4(B), the stage coordinate is x−L, and the inspection is performed at the corresponding position. At this time, the substrate coordinate x, located at the distance L from the inspection position on the substrate, is in a state 225 in which z is being measured. Then, the inspection progresses and the stage moves by the distance L as shown in the lower part of FIG. 4(B). Then, in a state 226, the stage coordinate is x, and the inspection is performed at the corresponding position.

That is, when only the substrate coordinate x is noted, for the upper stage coordinate x−L, the position of the substrate coordinate x is subjected to z measurement. The measured value is stored as the Zoff(x−L) 222. Then, when the substrate coordinate x position, located at the distance L from the upper stage coordinate x−L, the Zon(x) is required. Thus, the previously measured and stored DZ(x) 223 is added to the newly stored Zoff(x−L) 222 to determine the Zon(x). Based on the Zon(x), the substrate coordinate x position is subjected to auto-focusing, thus enabling unblurred, clear inspection image to be obtained. The consecutive repetition of the z measurement and the inspection allows the inspection to be appropriately carried out.

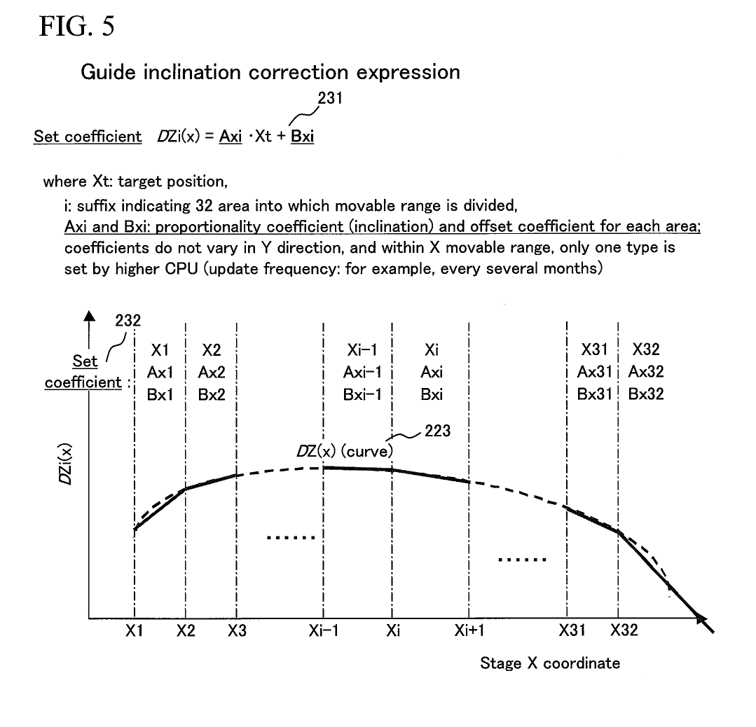

FIG. 5 shows a method for preparing the above-described DZ(x) 223. As described above, a standard substrate or the like is prepared. The substrate is then moved from end to end in the direction (in the present embodiment, the direction along the x axis) in which the stage is moved during inspection, while the height Zon_opt(x) of the optical focal position is measured, with the measured value Zoff(x−L) 222 determined. Based on the difference between the height Zon_opt(x) and the measured value Zoff(x−L) 222, the DZ(x) 223 (curve) is determined for each stage coordinate. In the example shown in FIG. 5, 32 points are measured. The substrate is partitioned into areas so that each of the areas surrounded by any of the 32 points. The inside of each of the areas is linearly approximated. This enables the DZ(x) 223 to be discretely stored using data including 32 proportionality coefficients AXi and 32 offset coefficients Bxi 232 as shown in the expression 231 in the figure. To allow this method to be used, an x coordinate Xt to be determined and the coefficients for the area corresponding to the Xt are substituted into the expression 231 to determine the DZ(x) 223.

The present embodiment uses the position offset from the beam optical axis in the x axis direction by the distance L. Thus, the present embodiment considers the inclination in the x axis direction to be dominant. Consequently, the example of the inspection in the x axis direction has been described. However, of course, the present invention is not limited to this aspect. Furthermore, the present embodiment assumes that the inclination of the x direction guide does not vary in the y direction. However, the present invention is not limited to this aspect. If the inclination varies in the y direction, the set coefficient 232 has only to be two-dimensionally expanded also in the y direction. Additionally, the coefficient 232 may be varied by the condition of the stage or other environmental conditions. The coefficient 232 may thus be periodically measured and updated.

Furthermore, the height measuring instrument requiring the correction process based on the stage movement as described above is not limited to the reflected light-type measuring instrument described in the present embodiment. The need for the correction process based on the stage movement relates to the usage of the height measuring instrument rather than the type thereof. That is, the correction process based on the stage movement is required when the height measuring instrument is used such that the height measurement point is at the distance L from the beam optical axis (inspection point) as shown in FIGS. 3 and 4, in other words, when the height measurement is not a real-time process for the inspection. Conversely, provided that the height measurement is a real-time process, for the inspection based on the continuous stage movement, the stage position during the inspection serves directly as the height measurement position whatever height measuring instrument is used. Thus, no error occurs in the height detection based on the stage movement.

### <Example of the GUI>

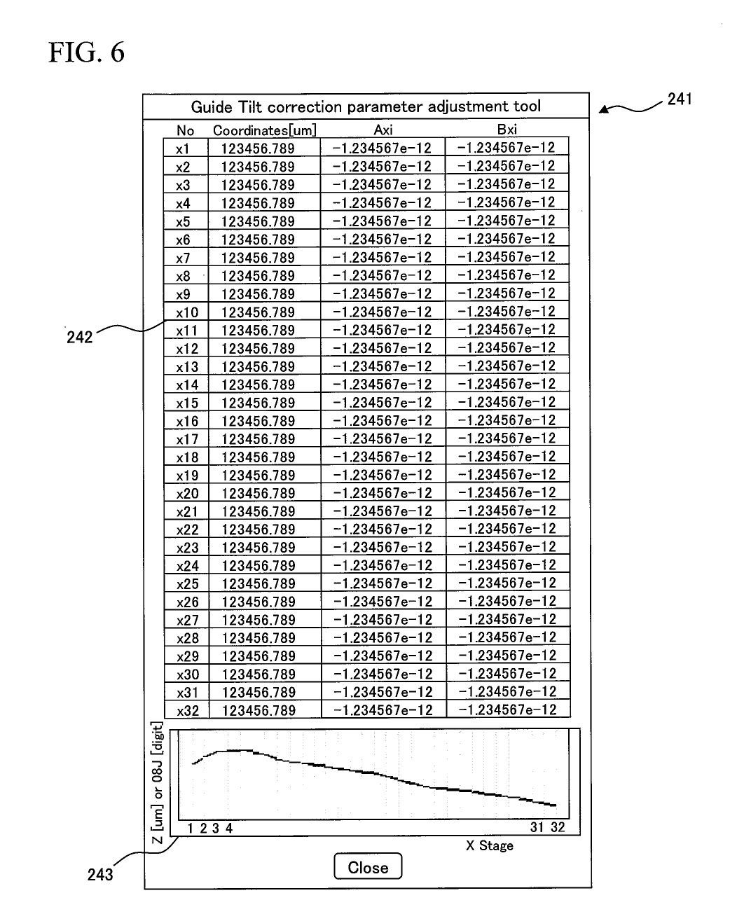

FIG. 6 shows an example of the GUI (Graphical User Interface) displayed on the display 50 according to the present invention. To create the correction data DZ(x) 223, shown in FIG. 5, or as means for checking the data in use, a GUI screen 241 shown in FIG. 6 is used. In the screen, reference numeral 242 denotes a set coefficient for the linear approximation of the correction data acquired. Reference numeral 243 denotes a graph display based on the coefficient. The graph display provides the overwrite display function of overwriting past data to allow the easy determination of whether the data is normal or abnormal. Furthermore, periodically acquiring and updating the correction data allows the apparatus to be checked for the condition thereof, particularly changes around the stage guide. This advantageously allows a maintenance period to be easily determined.

### (2) Second Embodiment

In a second embodiment, description will be given of the use of a height measuring instrument based on a scheme different from that in the first embodiment, for example, laser interferometer-type shape measuring instrument or an electrostatic capacitance-type displacement meter. The remaining part of the configuration of the second embodiment is similar to that of the first embodiment and will thus not be described.

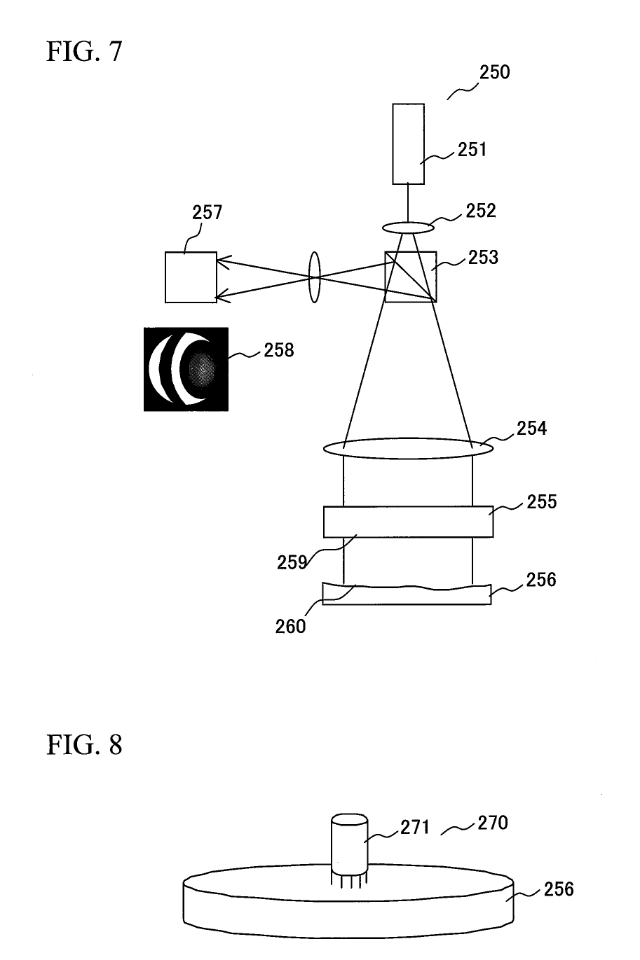

FIG. 7 is a diagram schematically showing the configuration of a laser interferometer-type shape measuring instrument (Fizeau interferometer) 250. With reference to FIG. 7, the principle of the height measurement will be described. In the laser interferometer-type shape measuring instrument 250, a laser beam from a laser head 251 passes through a divergence lens 252, a beam splitter 253, and a collimator lens 254. The laser beam then becomes parallel light, which reaches a precisely polished planar glass plate called a reference plate 255. Part of the light is reflected by a reference plane 259. After passing through the reference plate, the remaining part of the light reaches an inspection target plane 260 of a sample (substrate) 256, by which the remaining part is reflected. The reflected light from the reference plane 259 and the reflected light from the inspection target plane 260 turn back along the original optical path while interfering with each other, and are guided to an image producing element (CCD camera) 257 by a beam splitter 253. Thus, an interference fringe image 258 is obtained. The reference plane is very precisely polished and has only recesses and protrusions corresponding to at most half the wavelength of the light (at most 30 nm). With the Fizeau interferometer, only an air distance is present between the reference plane and the inspection target plane. Any parts of the light travel along the same path before reaching the reference plane. Thus, the difference between the reference plane and the inspection target plane results in the interference fringes (the reference plane is very precise and the difference corresponds to the shape of the substrate surface, which is virtually the inspection target plane).

As described above, when a smooth plane such as a substrate is irradiated with coherent light such as laser light, interference fringes may be generated owing to the slight unevenness of the smooth plane. Thus, reading the interference fringes allows relative unevenness information on the smooth plane to be obtained. This scheme has the advantage of allowing the entire surface of the substrate to be measured at a time, while having the disadvantage of obtaining only the relative height. Thus, to achieve the height measurement, the laser interferometer-type shape measuring instrument needs to be combined with a sensor such as an electrostatic capacitance-type displacement meter 270 which has only a partial measurement range but enables absolute positions to be measured as shown in FIG. 8.

The electrostatic capacitance-type displacement meter 270 is based on the measurement principle that the electrostatic capacitance between two parallel flat plates is in inverse proportion to the distance between the two poles. One of the flat plates is the measurement target (substrate) 256, and the other is a sensor (probe) 271. The sensor has a size of the order of millimeters and can thus measure only a local range during a single operation. However, unlike the above-described laser interferometer type 250, the electrostatic capacitance-type displacement meter is advantageous in that it is able to measure the absolute position (in this case, the height).

Both schemes (laser interferometer-type shape measuring instrument and electrostatic capacitance-type displacement meter) have advantages and disadvantages. Independently applying each of the schemes to the height sensor for which the present invention is intended is difficult. Thus, the present invention constructs a height sensor based on a combination of the two schemes.

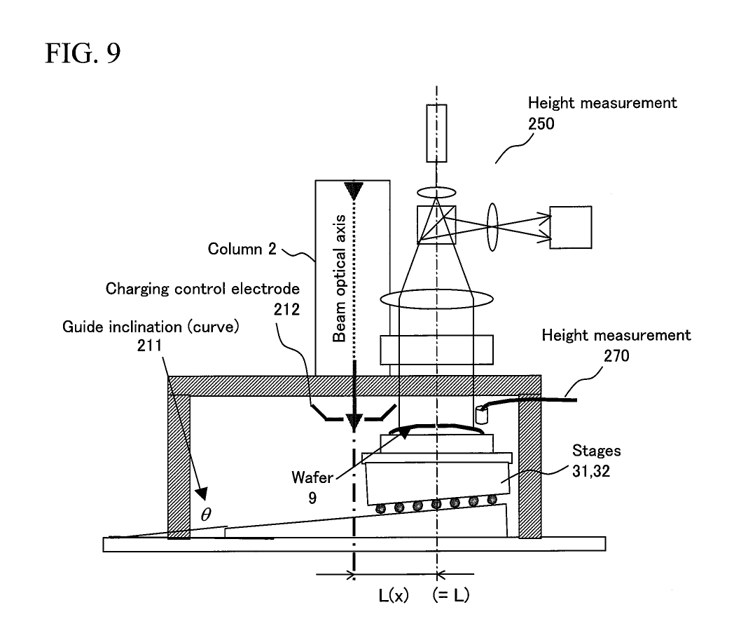

FIG. 9 is a diagram schematically showing the configuration of the height sensor constructed by combining the laser interferometer-type shape measuring instrument and the electrostatic capacitance-type displacement meter. The laser interferometer-type shape measuring instrument and the electrostatic capacitance-type displacement meter may be used for measurement in any order. For example, first, the laser interferometer-type shape measuring instrument 250 is used to obtain relative height information on the whole substrate. Subsequently, the electrostatic capacitance-type displacement meter 270 is used to measure the absolute height of a part of the substrate. Thus, the absolute height of the whole substrate is determined.

The method of measuring the substrate height as described above inevitably has difficulty carrying out the real-time process linked with the inspection operation involving the stage movement. In view of the size of the electrostatic capacitance-type probe sensor or the measurement principle of the laser interferometer, sequential measurement of the height of a part irradiated with a beam is impossible. Thus, before electron beam irradiation, the stationary substrate surface is irradiated with laser, and the absolute height of a part of the substrate is measured using the electrostatic capacitance-type sensor. Data on the pre-measured height of all or part of the substrate surface is stored as discrete table data. Thus, during inspection, the table data is referenced based on the stage position coordinate to obtain the height information.

As described above, also in this case, the stage position varies between when the height data is measured and when the height data is referenced (during the inspection of the substrate). An error in the inclination of the stage guide corresponding to the difference in position is reflected in the height data. In the scheme shown in the first embodiment, the difference in position corresponds to the distance L and is always constant. However, in the second embodiment, as shown in FIG. 9, a single stage position is used to measure the height data. Thus, the difference in position corresponds to the function of L(x) and the x coordinate. The relation shown in the first embodiment is therefore changed as follows.

Zon(x)=Zoff(x−L(x))+DZ(x) (2)

Here, the guide inclination correction curve DZ(x) is expressed by DZ(x)=Zon_opt(x)−Zoff(x−L(x)). The Zon_opt(x) is expressed in the same manner as in the first embodiment.

Furthermore, here, the L(x) is expressed as follows.

L(x)=L+x−w/2 (3)

Here, w denotes the substrate diameter (for example, 300 mm).

That is, when the inspection point is the center of the substrate (x=w/2), L(x)=L (this corresponds to the state shown in FIG. 9). If the x coordinate of the inspection point is smaller (x<w/2), L(x) is smaller than L. In contrast, the x coordinate of the inspection point is larger (x>w/2), L(x) is larger than L. The average of L(x) is L (this corresponds to the state shown in FIG. 9), which indicates a relatively large deviation in stage position compared to that in the first embodiment. The error in guide inclination corresponding to the positional deviation is expected to be a completely nonnegligible amount. Thus, without the correction scheme according to the present invention, the proper focus accuracy of the objective lens cannot be easily obtained.

Therefore, the present embodiment is also expected to achieve the improvement of the focus accuracy and defect detecting capability according to the present invention.

The configuration shown in FIGS. 4 and 5 for the first embodiment also applies to the second embodiment without a change except that L in the figures is replaced with L(x). The actual application of the correction equation is also exactly the same for both the first and second embodiments. Thus, the configuration shown in FIGS. 4 and 5 and the actual application of the correlation equation are not described.

### (3) Summary of the First Embodiment and the Second Embodiment

According to the embodiments of the present invention, a defect that cannot be detected in an optical image is detected using the electron beam image. Thus, the defect can be accurately detected.

Furthermore, the charging control electrode inhibiting the possible adverse effect of the charging is provided in the vicinity of the electron beam irradiation position on the substrate. Consequently, the measurement position (the installation position of the height sensor) at which the distance (height) between the objective lens and the substrate is measured cannot be aligned with the position of the optical axis of the electron beam on the stage coordinate. Thus, according to the present invention, the height of the substrate is measured at the position offset from the optical axis of the electron beam. When the stage is moved for defect detection, a deviation in height resulting from the movement is corrected. The corrected value is then used for focus control. Therefore, a possible decrease in the focus accuracy of the inspection image can be minimized.

Moreover, even if the sufficient contrast of the defect site fails to be obtained because of the characteristics of the substrate, excellent inspections can be achieved to provide a very sensitive defect detecting capability.

### (4) Third Embodiment

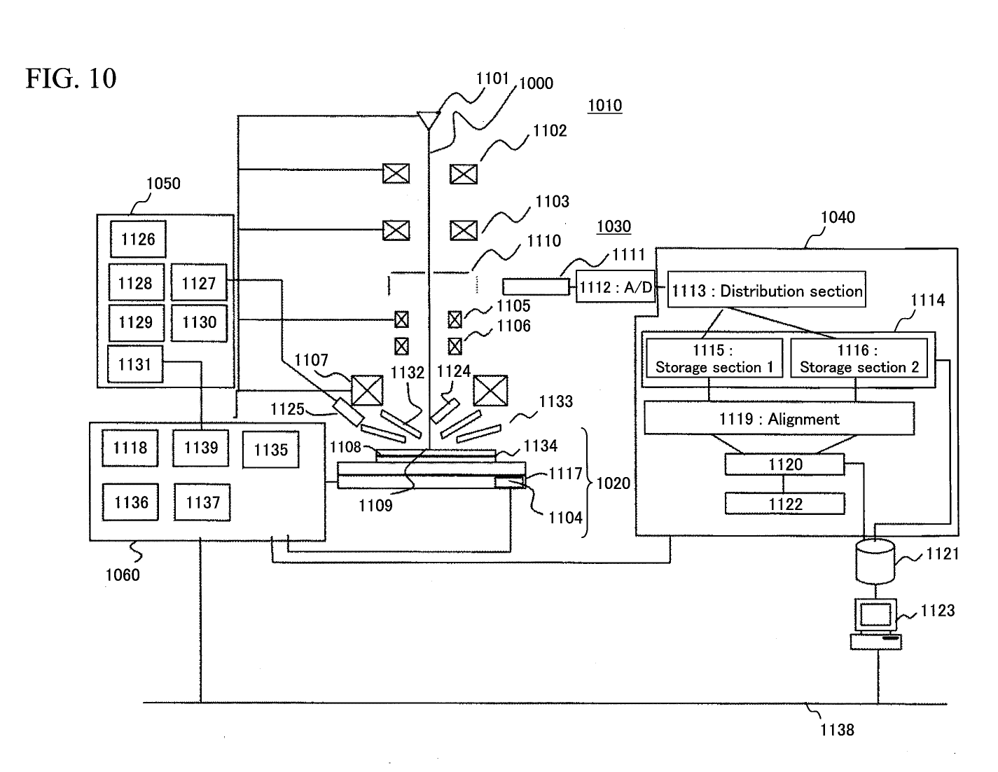

FIG. 10 is a diagram showing the general configuration of an SEM-type inspection apparatus.

The inspection apparatus as a whole is composed of an electronic optical system 1010, a table control system 1020, a detection system 1030, an image processing system 1040, a height detecting system 1050, a control system 1060, a secondary storage device 1121, and a computer 1123. The inspection apparatus is connected to a network 1138.

The electronic optical system 1010 includes an electron gun 1101, condenser lenses 1102 and 1103, polarizers 1105 and 1106, an objective lens 1107, a surface field control plate 1132, and a shield electrode 1133.

The table control system 1020 includes a substrate holder 1134, an XY stage 1117, and a stage position measuring section 1104 such as a laser length measuring instrument.

The detection system 1030 includes an ExB polarizer 1110, an electron detector 1111, and an A/D converter 1112.

The image processing system 1040 includes a distribution section 1113, a storage section 1114 having a storage section (1) 1115 and a storage section (2) 1116, an alignment section 1119, a difference calculating section 1120, and a large-difference area extracting section 1122.

The height detecting system 1050 includes a light pattern projecting section 1124, a light pattern image producing section 1125, a pattern storage section 1126, a height calculating section 1127, a height calculation result storage buffer 1128, an in-plane height calculating section 1129, a storage section 1130, and a height data correction amount calculator 1131.

The control system 1060 includes a polarization controlling section 1118, a sequence controlling section 1135, a stage controlling section 1136, an electronic optical system controlling section 1137 and a focusing section 1139.

The operation of each of the sections of the above-described configuration will be described below.

An electron beam emitted by the electron gun 1101 passes through the two condenser lenses 1102 and 1103 and is then polarized by the X polarizer 1105 and the Y polarizer 1106. Then, an electron beam irradiation area 1109 on a substrate 1108 that is a semiconductor wafer is irradiated with the electron beam via the objective lens 1107. Secondary electrons and reflected electrons are generated in the electron beam irradiation area 1109 irradiated with the electron beam. The secondary electrons and reflected electrons are polarized by the ExB polarizer 1110 via the objective lens 1107 and then detected by the electron detector 1111.

The potential of the surface field control plate 1132 can be set positive or negative with respect to the substrate 1108. The potential of the shield electrode 1133 is set the same as that of the substrate 1108. The semiconductor substrate 1108 is held on a substrate holder 1134 that attracts the substrate using an electrostatic capacitance. The A/D converter 1112 converts the analog electric signal output by the electron detector 1111 into a digital signal.

The distribution section 1113 distributes the digital signal output by the A/D converter 1112 to the storage section (1) 1115 or (2) 1116 of the storage section 1114 for storage. In the description of the present embodiment, signals detected in at least two dies for comparison is stored in the storage section (1) 1115 as a reference image. Signals detected in the at least two dies for comparison is stored in the storage section (2) 1116 as an inspection image.

The XY stage 1117 includes a stage position measuring section 1104 such as a laser length measuring instrument. Positional information on the XY stage 1117 measured by the stage position measuring section 1104 is input to the polarization controlling section 1118 to control the X polarizer 1105 and the Y polarizer 1106. Thus, when images are produced with the substrate 1108 continuously moved in one direction, the electron beam is allowed to scan the substrate in a direction orthogonal to the moving direction of the XY stage 1117. Consequently, two-dimensional images are stored in the storage section 1114.

During movement of the XY stage 1117, the polarization controlling section 1118 fine-tunes the X polarizer 1105 and the Y polarizer 1106 so as to allow images of the same pixel size to be acquired even with variation in stage movement speed. In a different mode, with the XY stage 1117 remaining stationary, the X polarizer 1105 and the Y polarizer 1106 allow the electron beam to perform two-dimensional scan on a visual field. This allows two-dimensional images to be acquired. The alignment section 1119 aligns the reference image with the inspection image based on a well-known alignment technique using the peak of normalized correlation of the output images, the minimum value of the square sum of the difference between the two images, the absolute value of the difference, or the like. Based on the result of the alignment, the difference calculating section 1120 compares the two images containing the same pattern, to calculate the difference.

The secondary storage device 1121 saves inspection parameters. The large-difference area extracting section 1122 outputs, as a defect, an area with a large difference output by the difference calculating section 1120 based on the inspection parameters stored in the secondary storage device 1121. If the difference calculating section 1120 inputs the characteristics of the images to the large-difference area extracting section 1122, the large-difference area extracting section 1122 may make determination also using the characteristics of the images input by the difference calculating section 1120. Furthermore, the secondary storage device 1121 is set such that images stored in the storage section (1) 1115 or (2) 1116 of the storage section 1114 can be input to the secondary storage device 1121 for storage. The secondary storage device 1121 can further store the coordinates of defects extracted by the large-difference area extracting section 1122, and the characteristics of images output to the difference calculating section 1120. The computer 1123, having the GUI terminal, displays extracted areas suspected to be severely affected by a process variation, on a substrate map. The computer 1123 is connected to an external LAN 1138 so that any external apparatus can input the inspection parameters to the computer 1123 and the computer 1123 can output acquired images and inspection results to the external apparatus.

The light pattern projecting section 1124 illuminates the surface of the substrate 1108 with a light pattern via an optical path formed in the shield electrode 1133. The light pattern may be one or more line patterns or one or more point patterns. Alternatively, a combination of a line and a pattern may be used. The light pattern is applied to the surface of the substrate 1108 at a position offset from the optical axis 1000 of the electronic optical system shown in FIG. 10. In the present embodiment, the light pattern is applied to the surface of the substrate 1108 at a position offset from the optical axis 1000 of the electronic optical system in the stage scanning direction by, for example, 15 mm. An irradiation angle in the vertical direction is set to, for example, 80 degrees to the normal of the substrate.

The light pattern image producing section 1125 produces an image of the light pattern applied to the surface of the substrate 1108 by the light pattern projecting section 1124. The pattern storage section 1126 stores the image of the light pattern applied to the surface of the substrate 1108 which image is produced by the light pattern image producing section 1125. The height calculating section 1127 processes the image stored in the pattern storage section 1126 to determine the position of the line or point pattern applied onto the substrate 1108. Then, based on the position obtained, the height calculating section 1127 performs the proper calculation using the principle of triangulation. The height calculation result storage buffer 1128 stores the substrate height calculated by the height calculating section 1127 based on the output value from the stage position measuring section 1104, and the substrate position corresponding to the height measurement; the substrate height and the substrate position are associated with each other. The combination of the light pattern projecting section 1124 and the light pattern image producing section 1125 is hereinafter referred to as the height sensor.

Variation in the height of the substrate 1108 varies the position of the light pattern applied to the surface of the substrate 1108 by the light pattern projecting section 1124, that is, the substrate position at which the height is measured. This in turn varies, in the horizontal direction, the irradiation position of the light pattern on the substrate 1108 the image of which position is produced by the light pattern image producing section 1125. Thus, the amount of the variation is calculated to determine the position of the height measurement.

The in-plane height calculating section 1129 calculates the height of the whole or a partial area of the substrate 1108 based on a plurality of height calculation results stored in the height calculation result storage buffer 1128. In the storage section 1130, which stores the data on the in-plane height of the substrate 1108 obtained by the in-plane height calculating section 1129, the substrate height and the corresponding measurement position are stored in association with each other based on an output from the stage position measuring section 1104. Then, based on the output from the stage position measuring section 1104, the substrate height data corresponding to the optical axis 1000 of the electronic optical system is output.

The height data correction amount calculator 1131 compares the height data pre-stored in the storage section 1130 with height data acquired later at the same position. Then, based on the comparison of the data obtained at the different timings, the height data correction amount calculator 1131 corrects the pre-calculated height data. The focusing section 1139 contains a mechanism that controls an excitation current for the objective lens in the SEM. The height calculation result storage buffer 1128 is connected directly to the focusing section 1139. Based on the output data from the stage position measuring section 1104, the height calculation result storage buffer 1128 outputs the already stored substrate height data corresponding to the optical axis 1000 of the electronic optical system, similarly to the storage section 1130. The sequence controlling section 1135 controls the operation of the apparatus as a whole. The stage controlling section 1136 controls the movement of the XY stage 1117 based on a sequence from the sequence controlling section 1135. The electronic optical system controlling section 1137 controls a beam current for the electronic optical system 1010 and the excitation current for an electron lens, for example, the objective lens 1107.

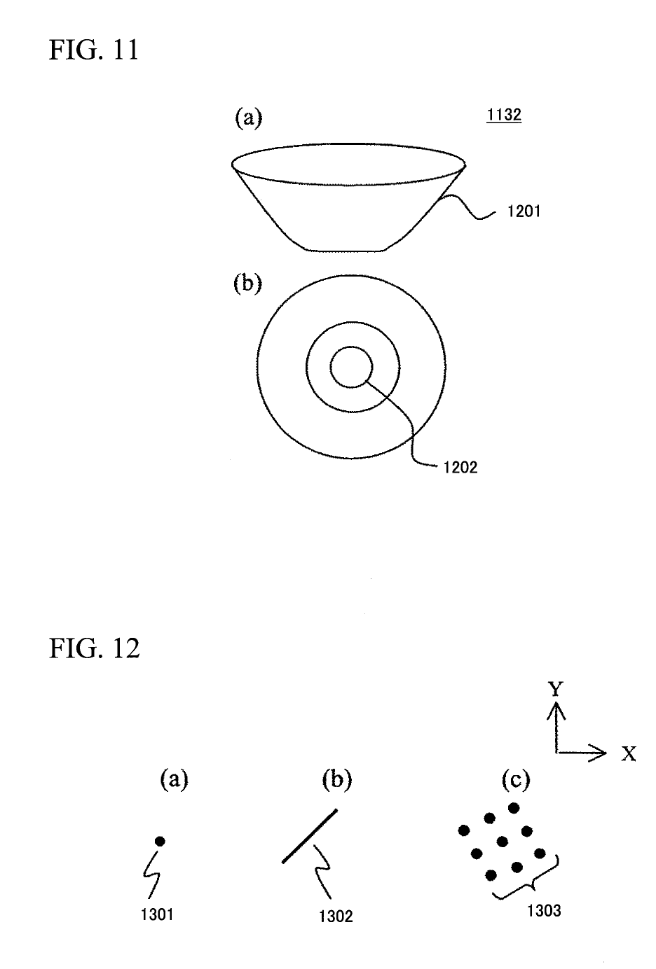

FIGS. 11(A) and 11(B) show the structure of the surface field control plate 1132. FIG. 11(A) is a perspective view of the surface field control plate 1132. FIG. 11(B) is a plan view of the surface field control plate 1132. In the vicinity of the optical axis 1000 of the electronic optical system, the surface field control plate 1132 is located in proximity to the substrate 1108 so as to reduce the possible aberration of the electron beam applied to the substrate 1108. On the other hand, to prevent illumination light for height measurement and reflected light from the substrate 1108 from impinging on the surface field control plate 1132, the surface field control plate 1132 is basically shaped like a cone 1201 such that the distance from the surface field control plate 1132 to the substrate 1108 increases toward a peripheral portion thereof. A hole 1202 is formed in a central portion of the surface field control plate 1132 so as to allow the electron beam and secondary electrons to pass through. To make the surface fields uniform, a part of the surface field control plate 1132 which is close to the optical axis 1000 of the electronic optical system has a surface parallel or nearly parallel to the substrate 1108. The electron beam and secondary electrons suffer little impact at positions distant from the optical axis 1000 of the electronic optical system. Thus, the shape of the surface field control plate 1132 is nearly unlimited and has only to be rotationally symmetric. Consequently, the surface field control plate 1132 may be differently shaped so as to prevent the illumination light for height measurement from impinging on the surface field control plate 1132. For example, the surface field control plate 1132 may have a dome shape projecting downward.

FIGS. 12(A) to 12(C) show examples of light patterns with which the light pattern projecting section 1124 illuminates the substrate 1108. FIG. 12(A) shows a light pattern 1301 obtained when the light pattern projecting section 1124 emits a point beam. FIG. 12(B) shows a light pattern 1302 obtained when the light pattern projecting section 1124 emits slit light. FIG. 12(C) shows a light pattern 1303 obtained when the light pattern projecting section 1124 emits a plurality of point beams. In the example shown in FIG. 12(A), if any substance with a different reflectance is present at the electron beam irradiation position 1109 on the substrate 1108, lightness may change at the position on which the light pattern impinges. This disadvantageously causes the position of the pattern detected by the light pattern image producing section 1125 to deviate. For example, if the illumination has a numerical aperture NA of 0.05 and the illumination light provided by the light pattern projecting section 1124 is laser light with a wavelength of 532 nm, the beam diameter is about 6.3 μm. Thus, if the incident angle of the illumination light is 80 degrees to the normal of the substrate, a possible height error is about 3.2 μm. This value significantly exceeds a focal depth required for high-resolution SEM image production for which the present invention is intended, that is, at most 1 μm, and can thus not be adopted.

In a semiconductor device pattern formed on the substrate 1108, a boundary with a different reflectance is often present in the horizontal or vertical direction owing to variation in pattern density depending on the area of the substrate. Thus, as shown in FIG. 12(B), a slit-like light pattern is obliquely projected on the semiconductor device pattern formed on the substrate 1108. Then, the height of the substrate 1108 can be very accurately detected. This is because the light pattern in FIG. 12(B) sharply reduces the ratio of the area of the boundary in the pattern having the different reflectance to the irradiation area covered by the slit-like light pattern compared to that in FIG. 12(A), thus drastically reducing a possible height measurement error. For example, it is assumed that the light pattern 1302 has a width of 1 mm in the longitudinal direction of the slit and that range of variation in the height of the substrate 1108 is 80 μm. Then, a change in the optical path of the reflected light of the light pattern 1302 caused by the variation in height corresponds to a distance of 150 μm. The direction of the slit is set at 60 degrees to the scanning direction of the stage. Furthermore, when a plurality of point beams are used for the illumination as shown in FIG. 12(C), the possible error can be avoided by using, for the height measurement, the reflected light of a point beam that does not overlap the boundary in the pattern having the different reflectance. To maximize this effect, the array of the plurality of point beams needs to be illuminated at any angle to the semiconductor pattern except 90 degrees as shown in FIG. 12(C).

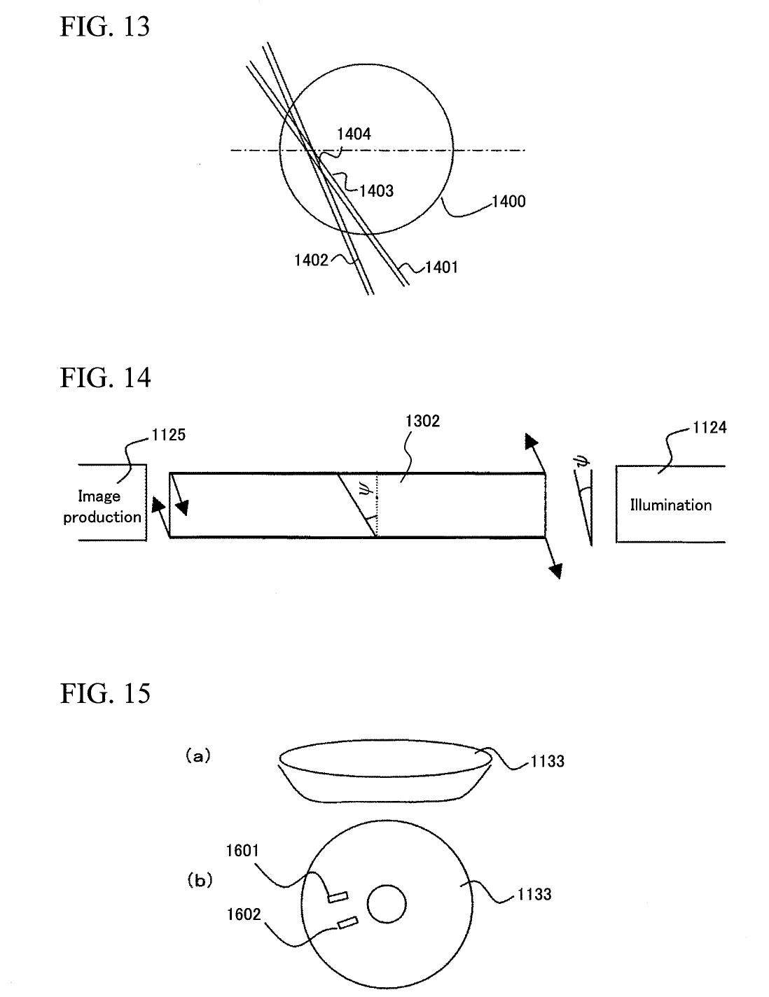

FIG. 13 shows an example of a technique of measuring the height of the substrate using the slit light shown in FIG. 12(B). If with respect to the size of an SEM column 1400, the incident angle in the horizontal direction is 60 degrees to the stage scanning direction, the slit light travels in a direction 1401. If the incident angle in the horizontal direction is 75 degrees to the stage scanning direction, the slit light travels in a direction 1402. A height measurement position 1150 needs to be set such that when the XY stage 1117 is moved in the X direction, SEM images are produced after the height measurement. However, if the incident angle of the slit light pattern 1302 in the horizontal direction is smaller than 90 degrees, the position closest to the optical axis 1000 differs from the position to which the pattern is applied. If the incident angle in the horizontal direction corresponds to the direction 1401, a position 1403 is closest to the optical axis 1000. If the incident angle in the horizontal direction corresponds to the direction 1402, a position 1404 is closest to the optical axis 1000. Thus, the height measurement is disadvantageously affected by the interference of the electrode or objective lens with the magnetic path at the positions 1403 and 1404.

The distance between the optical axis 1000 of the electronic optical system and the slit light irradiation position is defined as ΔX, and the incident angle in the horizontal direction is defined as φ. Then, the distance D from the optical axis 1000 of the electronic optical system at the closest position is expressed by:

D=ΔX sin φ (4).

Thus, to reduce the interference of the electrode or the objective lens, the incident angle φ needs to be as close to 90 degrees as possible. However, when the incident angle of the slit light pattern 1302 is close to 90 degrees, this direction is very likely to be the same as that of the boundary on the substrate 1108 having the different reflectance, for example, the boundary of the pattern area. This is prone to cause a height detection error. Thus, in the embodiment of the present invention, the slit light pattern 1302 is rotated during incidence.

FIG. 14 is an enlarged view of the slit light pattern 1302. The light pattern 1302 is projected between the light pattern projecting section 1124 and the light pattern image producing section 1125. The light pattern 1302 is rotated by an angle φ. When the incident angle of the light pattern 1302 in the vertical direction is θ, the rotation angle ψ of the light pattern on the substrate is expressed by:

ψ=a tan(tan φ/sin θ) (5).

Thus, even with an increase in the incidence angle φ in the horizontal direction, the angle between the light pattern 1302 and the stage scanning direction can be reduced. In the present invention, the angle φ was set to 2 degrees so that the light pattern 1302 inclined, on the substrate 1108, at −14 degrees to the incident angle in the horizontal direction. Thus, even when the incident angle of the light pattern 1302 in the horizontal direction was 74 degrees, the angle of the slit was successfully set to 60 degrees.

To make the slit light pattern 1302 horizontal for detection, the light pattern projecting section 1124 is mounted at an angle of −2 degrees. Then, in the present embodiment, a position on the optical path which is closest to the optical axis of the electronic optical system corresponds to a distance of 13.4 mm from the optical axis, including the slit size. At this position, the distance from the substrate 1108 to the optical path in the vertical direction is about 900 μm if the height of the substrate 1108 varies within a range with a maximum value of 80 μm. Thus, in the present embodiment, the surface field control plate 1132 is designed to lie at least 1 mm away from the substrate 1108 at a position 13.4 mm away from the optical axis 1000.

The structure of the shield electrode 1133 is shown in FIG. 15. FIG. 15(A) is a perspective view of the shield electrode 1133 shaped like a dish. The shield electrode 1133 is provided to inhibit the possible disturbance of electric fields caused by, for example, variation in the height of the edge of the end of the substrate 1108 when SEM images of the end of the substrate 1108 are produced. The potential of the shield electrode 1133 is set the same as that of the substrate 1108. A voltage higher than that for the substrate 1108 by several kV may be set for the surface field control plate 1132. Thus, when the surface field control plate 1132 is located in proximity to the substrate 1108, discharging may occur. Thus, the closeness of the surface field control plate 1132 to the substrate 1108 is limited. However, since the potential of the shield electrode 1133 is set the same as that of the substrate 1108, the shield electrode 1133 can be located closer to the substrate 1108 than the surface field control plate 1132. Furthermore, locating the shield electrode 1133 as close to the substrate 1108 as possible allows the optical path to be inhibited from disturbing the electric fields.

Slots 1601 and 1602 shown in FIG. 6(B) are each formed as an optical path through which the illumination light from the shield electrode 1133 passes. Setting the optical path for the slot 1601 requires consideration for the illumination of the slit light 1302 and the numerical aperture NA of the detection system. By way of example, dimensions will be shown with machining accuracy taken into account. Both slots 1601 and 1602 have a size of 1.3 mm×400 μm. The gap between each of the slots and the substrate 1108 is 0.5 mm.

In the present embodiment, the optical paths are formed in the shield electrode 1133. However, the size of the surface field control plate 1132 may be increased so that the optical paths can be formed in the surface field control plate 1132. However, when holes are formed in the surface field control plate 1132, the electric fields are more severely disturbed partly because the voltage applied to the surface field control plate 1132 differs significantly from the substrate potential. Thus, to prevent the disturbed electric fields from affecting the area irradiated with the electron beam, the irradiation position 1109 of the slit light 1302 needs to be located further away from the optical axis 1000 of the electronic optical system.

An alternative method is to form a space between the surface field control plate 1132 and the shield electrode 1133 without forming an optical path in the shield electrode 1133 so that the slit pattern can be projected and detected using the space as an optical path. However, this excessively increases the distance between the shield electrode 1133 and the optical axis 1000 of the electronic optical system. Thus, the electron beam may be unstable when the outer peripheral portion of the substrate 1108 is inspected.

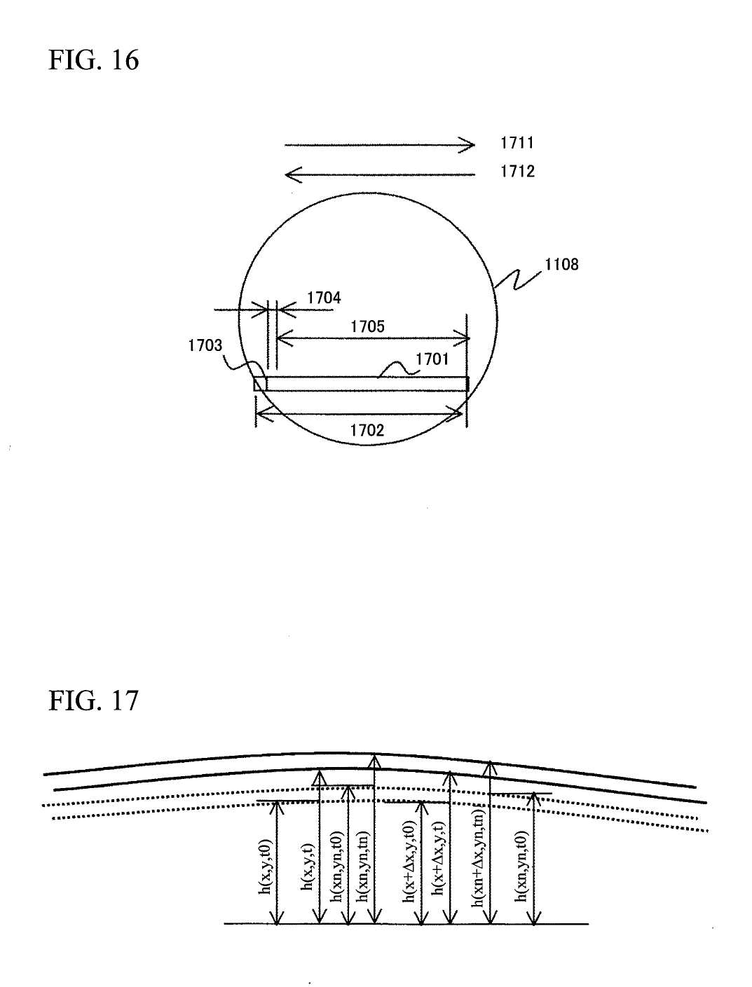

FIG. 16 shows an inspection area. When an inspection area 1701 on the substrate 1108 is inspected, an SEM image is produced only for the inspection area 1701. When an image of the substrate 1108 is produced from left to right, the height measurement is first performed. Then, the resulting height measurement data is used to correct the focus of the electron beam to acquire an image. In the example shown in FIG. 16, the light pattern projecting section 1124 and light pattern image producing section 1125 of the height detecting system 1050 are arranged to the right of the optical axis. The XY stage 1117 is moved from right to left with the electron beam allowed to scan the substrate over the width of the inspection area 1701 in the Y direction. Thus, an image of the inspection area 1701 is produced from left to right as shown by arrow 1711. In the present embodiment, there is a distance of 15 mm between the height measurement position and the optical axis 1000 of the electronic optical system of the SEM, which corresponds to the position at which the SEM image is produced. Consequently, when the height measurement position is aligned with the left end of the inspection area 1701, the optical axis 1000 of the electronic optical system lies 15 mm leftward away from the inspection area 1701. Therefore, the XY stage 1117 needs to be moved over a distance corresponding to an area 1703 that is longer than the inspection area 1701 by 15 mm.

When the electron beam is allowed to scan the substrate from left to right as shown by arrow 1711, focus control is performed in view of a time delay corresponding to the distance from the position of the height measurement to the position of the SEM image production. Here, the travel speed of the XY stage 1117 is not always constant. Thus, the focus control needs to take the alignment between the height measurement point and the intended point of the SEM image production into account.

With the height measuring method according to the present embodiment, if particularly an SEM image is produced using fine pixels with a size of, for example, at most 50 nm and an image sensor that is movable at 1×10⁵ pixels/sec is used, then the stage movement speed is about 5 mm/sec. In contrast, the height measurement requires a pixel size of only about 500 nm and can be performed at a stage movement speed of about 50 mm/sec. Thus, for an area for which no SEM image is produced but the height is measured, the stage movement speed may be increased to allow throughput to be improved. The stage movement speed is increased for, for example, an area for which the height is measured immediately after the stage movement is started or a chip boundary or the like for which no image is produced because of the absence of an inspection pattern. Then, even if the time required to move the XY stage 1117 increases by an amount corresponding to the height measurement, the increase can be limited to about 1 second. Since the stage movement speed is changed during the inspection, the association between the height measurement point and the image production point needs to be controlled. This control complicatedly varies the movement speed of the XY stage 1117. Thus, as described below, based on an output from the stage position measuring section 1104, the value of the height of the SEM image production position 1109 is calculated with the association between the SEM image production position 1109 and the height measurement position. The value is then stored in the height calculation result storage buffer 1128. At this time, the focus of the electron beam is controlled based on the value of the height stored in the height calculation result storage buffer 1128.

To obtain the height measurement data corresponding to the distance of 15 mm between the optical axis 1000 of the electronic optical system and the height measurement position, the present embodiment allows the in-plane height calculating section 1129 to calculate the value of the height at the SEM image production position using an interpolation function such as a spline function, based on the height measurement data obtained at a plurality of positions displaced from one another in the X or Y direction. After the inspection area 1701, which is elongate in the X direction as shown in FIG. 16, is produced, the XY stage 1117 is moved in a direction opposite to the X direction, and an image of an inspection area is produced which area is located adjacent to the inspection area 1701 and has a width equal to the electron beam scanning width. This operation is repeated to allow inspection images of a plurality of inspection areas on the substrate 1108 to be produced. At this time, while inspection images are being produced, the height measurement data is obtained not only for the X direction but also for the Y direction. The height measurement data is stored in the height calculation result storage buffer 1128. Obtaining the height measurement data on a plurality of inspection areas allows the height measurement data for the X and Y directions of the substrate 1108 to be sequentially obtained. Thus, the in-plane height calculating section 1129 can calculate the height measurement data for the X and Y directions of the substrate 1108 using the interpolation function. The calculated height data is stored in the storage section 1130. The use of the interpolation function enables a reduction in the number of height measurement points and in the time required to acquire the height measurement data.

When the area 1702 shown in FIG. 16 is scanned from left to right as shown by arrow 1711, using the electron beam, the XY stage 1117 moves so as to allow the height of the area 1703 to be measured. The XY stage 1117 then moves so as to allow an SEM image of the area 1701 to be produced. If an SEM image of an area 1704 that is a part of the area 1701 is to be produced, the height value calculated based on the height measurement data for the area 1703 using the interpolation function is stored in the storage section 1130. The height value is used to control the focus of the electron beam for the area 1704. For the entire inspection area 1701 except for the area 1704, that is, an area 1705, the focus of the electron beam is controlled based on the height measurement data stored in the height calculation result storage buffer 1128.

The in-plane height calculating section 1129 uses the height measurement data stored in the height calculation result storage buffer 1128 and the previously acquired height measurement data to calculate the height data for the X and Y directions of the substrate 1108. The in-plane height calculating section 1129 stores the height data in the storage section 1130.

When the electron beam is allowed to scan the substrate from right to left as shown by arrow 1712 in FIG. 16, the focus control cannot be performed before the image production because the light pattern projecting section 1124 and light pattern image producing section 1125 of the height detecting system 1050 are arranged after the SEM image production point. Thus, the focus of the electron beam is controlled using the height measurement data obtained for the adjacent inspection area 1701 and stored in the storage section 1130. For example, the visual field of the SEM is at most 600 μm in length, and the slit length for the height measurement is 1 mm. Consequently, when the inspection areas are located adjacent to each other, no accuracy problem results from the focus control using the height data on the adjacent inspection area.

On the other hand, even when the electron beam is allowed to scan the substrate from right to left as shown by arrow 1712, the height measurement data is obtained and stored in the height calculation result storage buffer 1128. This value is used for the interpolative calculation of the in-plane height distribution of the substrate 1108 for not only the X direction but also the Y direction, together with the height measurement data obtained when the electron beam is allowed to scan the substrate from left to right as shown by arrow 1711. The calculation result is stored in the storage section 1130. Even the height measurement data on an inspection area with a length of less than 15 mm such as the area 1703 is used for the interpolative calculation of the height data.

In actuality, even when the height data obtained from the height measurement data using the interpolative calculation is used to control the focus of the electron beam, an error may still occur. This is due to deformation of the vacuum chamber in the SEM caused by variation in atmospheric pressure or outside temperature or variation in the height of the substrate over time caused by the deformation of the substrate per se. The results of the present inventors' examinations indicate that the substrate may be deformed by about several μm within about an hour. The apparatus for which the present embodiment is intended offers a focusing accuracy of at most 1 μm, which is insufficient for such a deformation.

Thus, if pre-measured height data is available, the pre-measured height data is compared with the height measurement data obtained during the SEM image production to determine the amount of a possible change. Then, based on this change amount, the height data correction amount calculator 1131 determines the amount by which the height is to be corrected. This will be described with reference to FIG. 17. Height measurement data obtained at certain coordinates (x, y) at a certain time t is expressed as a function of h using x, y, and t as variables; the height measurement data is defined as h (x, y, t). Height measurement data previously obtained at the same point is defined as h (x, y, t0). The distance between the optical axis 1000 of the electronic optical system and the height measurement point is defined as Δx.

In the present embodiment, the height h(x+Δx, y, t) of the point located Δx away from the optical axis 1000 of the electronic optical system can be measured in real time. The measurement requires an estimation based on:

h(x, y, t)−h(x+Δx, y, t) (6).

Here, Expression (7) is known.

h(x, y, t0)−h(x+Δx, y, t0) (7)

h (x, y, t0) and h (x+Δx, y, t0) cannot be measured at the same time. Thus, strictly speaking, this expression fails to indicate variation in height. However, the h (x, y, t0) and h (x+Δx, y, t0) are assumed herein to be measured at almost the same time, which is denoted by t0.

The height of a point h (xn, yn, tn) is determined which is closest to the coordinates (x, y) and for which the height has already been measured. Here, w in wx and wy denotes a weighting function, and a function f(t) is a suitably set function. The degree D_{L} of proximity is calculated, for example, as follows.

D_{L}=wx(xn−x)²+wy(yn−y)²+f(t−tn) (8)
In this case, h (x, y, t) is determined, for example, as follows.

h(x, y, t)=h(x+Δx, y, t)+h(x, y, t0)−h(x+Δx, y, t0)+h(xn, yn, tn)−[h(xn+Δx, yn, tn)+h(xn, yn, t0)−h(xn+Δx, yn, t0)] (9)

This expression can be considered to be the correction of the previously measured height measurement data based on the difference between estimated height data and actually measured height data in already measured height measurement data for points that are temporally and spatially close to each other. This calculation is performed by the height data correction amount calculator 1131.

To allow this calculation to be performed, the storage section 1130 stores height measurement data obtained for the same horizontal position at a plurality of timings or one height measurement data and a difference therefor. Instead of the height measurement data for each measurement point, a fitting function determined from the obtained height measurement data may be stored. This enables a reduction in the memory use amount of the storage section 1130.

The height measurement point h (x+Δx, y, t) may be located outside the end of the substrate 1108. In this case, the expression for the calculation of h (x, y, t) can be rewritten as follows.

h(x, y, t)=h(x, y, t0)+h(xn, yn, tn)−h(xn, yn, t0) (10)

According to Expression (10), if the height of the coordinates (xn, yn), which are close to the coordinates (x, y) of the target point, varies, then because of the absence of data obtained in real time at a time t in connection with Expression 4, an accuracy reduction factor is enhanced if there is a large difference between tn and t. Thus, the height h (xn, yn, tn) needs to be measured immediately before the production of SEM images. Consequently, an extra time is required for this pre-measurement. Thus, Expression (10) is used only if the real-time measurement cannot be performed. After the scanning enters an area for which the height can be measured in real time, the focus is controlled using Expression (9).

The above-described control allows the height to be estimated using not only the height measurement data obtained at the previous time t0 but also the height measurement data obtained in real time as well as the height measurement data for an area closest to the target coordinates. This enables very accurate focusing to be achieved.

To enable more accurate focusing, the height measurement data such as the height h (xn, yn, tn) or the height h (x, y, t0) may be replaced with the average value of a plurality of height measurement data obtained at nearby points. Furthermore, for example, the height of the substrate may be measured at a small number of points on the substrate. The resulting values may then be subjected to spline interpolation or quadratic interpolation to set substrate height measurement data obtained at the previous time to. This is desirable for reducing the preparation time before the inspection. To allow the above-described calculations to be performed, the height values measured at the same point at different points in time need to be stored. Thus, when combined together, data stored in the height calculation result storage buffer 1128 and storage section 1130, used to store the height measurement data, serve as substrate height information obtained at the same point at different timings.

### (5) Fourth Embodiment

In the scheme described in the third embodiment, an SEM image is obtained by allowing the electron beam to scan the substrate with the XY stage 1117 continuously moved. Now, a variation of the third embodiment will be described. In the variation, focusing is performed when an XY stage 1117 is intermittently moved, that is, in a step and repeat manner, so as to allow images of desired areas on a substrate 1108 to be sequentially produced, as in the case of, for example, a review SEM having the function of allowing sequential observation of a plurality of defects detected as a result of inspection of the substrate 1108 by another inspection apparatus and a length measuring SEM allowing the size of a pattern formed on the substrate 1108 to be sequentially measured at a plurality of points.

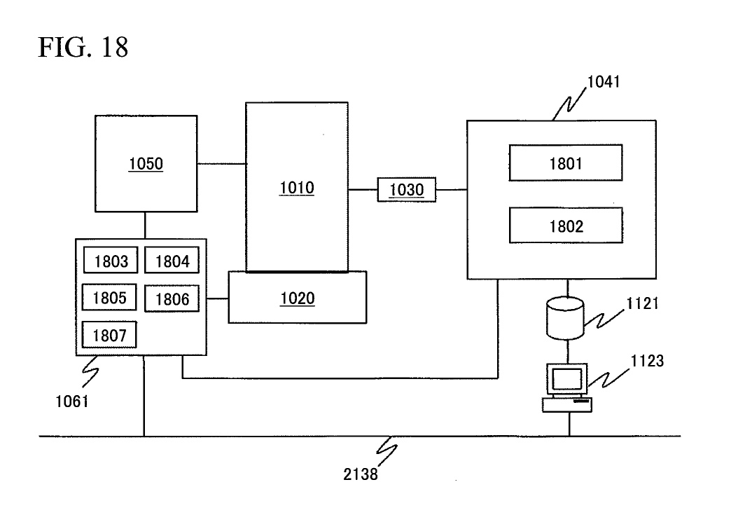

In the variation, at a time t0 before the image acquisition, no height measurement data on the substrate 1108 is acquired. Thus, the focus control needs to be performed at the position where height measurement data is obtained immediately before the image production. The configurations of an electronic optical system 1010, a table control system 1020, a detection system 1030, and a height detecting system 1050 in an SEM apparatus used to produce SEM images are basically the same as those described with reference to FIG. 10. However, the configurations of an image processing system 1041 and a control system 1061 are different from those described with reference to FIG. 10. The configuration of the present variation is schematically shown in FIG. 18.

The image processing system 1041 includes a storage section 1801 and an image processing section 1802. For the review SEM, the image processing section 1802 extracts an image of a defect from an SEM image of an inspection target area. For the length measuring SEM, the image processing section 1802 calculates the size of a measurement target pattern in the SEM image of the inspection target area.

On the other hand, the control system 1061 includes a polarization controlling section 1803, a sequence controlling section 1804, a stage controlling section 1805, an electronic optical system controlling section 1806, and a focusing section 1807. The sequence controlling section 1804 and the stage controlling section 1805 perform control corresponding to the functions of the review SEM or the length measuring SEM. The sequence controlling section 1804 and the stage controlling section 1805 thus moves the XY stage 1117 in a step and repeat manner and sequentially produces images of the desired areas on the substrate 1108.

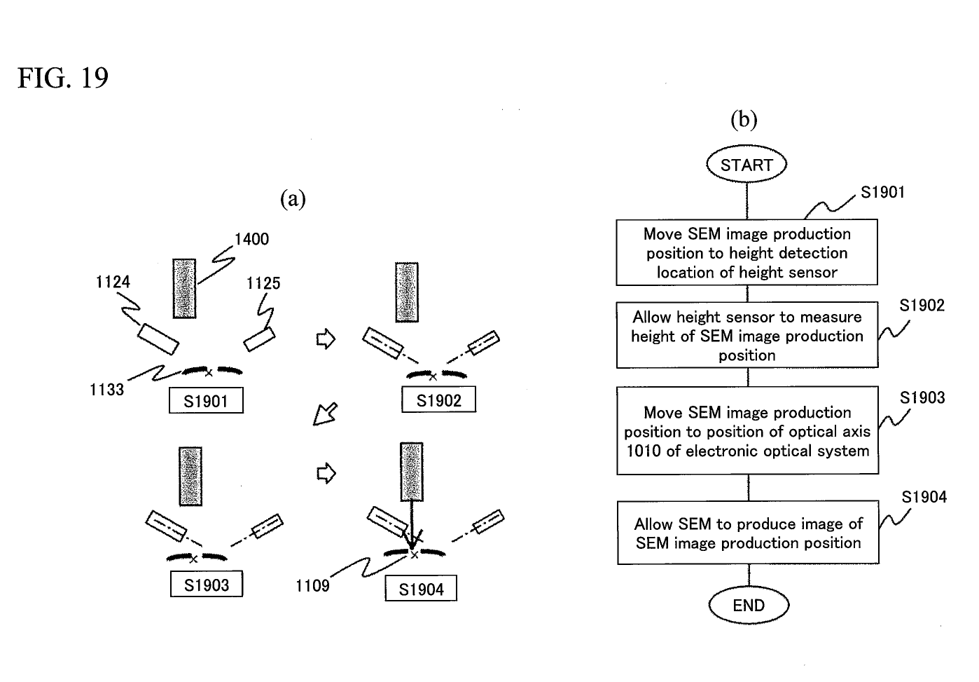

A sequence for the above-described control will be described with reference to FIG. 19. FIG. 19(A) is a vertical sectional view of the arrangement of an SEM column 1400, a light pattern projecting section 1124, a light pattern image producing section 1125, and a shield electrode 1133. FIG. 19(B) is a flowchart. If only a small number of points are to be subjected to image production, then before each SEM image production, the position of the XY stage 1117 is moved so that the height of an SEM image production position 1109 can be measured by a height sensor that is a combination of the light pattern projecting section 1124 and the light pattern image producing section 1125 (step 1901). Then, the height is measured (step 1902). Thereafter, the XY stage 1117 is moved again and set within the range in which an image of the SEM image production position 1109 can be produced by the SEM (step 1903). At that position, an SEM image is produced (step 1904). In step 1902, for the best throughput, the height measurement is desirably performed without stopping the XY stage 1117, that is, while the XY stage 1117 is being moved.

In another embodiment, in the review SEM or the length measuring SEM, the XY stage 1117 is moved to set an observation area or a measurement area on the substrate 1108 within the image production visual field of the SEM. Then, height measurement data may be obtained in real time at a position located Δx away from the optical axis and used to perform focusing. In particular, in the length measuring SEM or the review SEM, when an SEM image is produced, automatic focusing may be performed based on the SEM image. This eliminates the need for an accuracy of less than 1 μm, thus allowing the accuracy problem to be solved. In the embodiment shown in FIG. 10, described above, the substrate 1108 is held on the substrate holder 1134 including the electrostatic capacitance-type suction mechanism. Thus, even if Δx is about 15 mm, the corresponding amount of change in height can be limited to at most about 1 μm. Consequently, an initial value for the automatic focusing based on the SEM image can be determined without a problem.

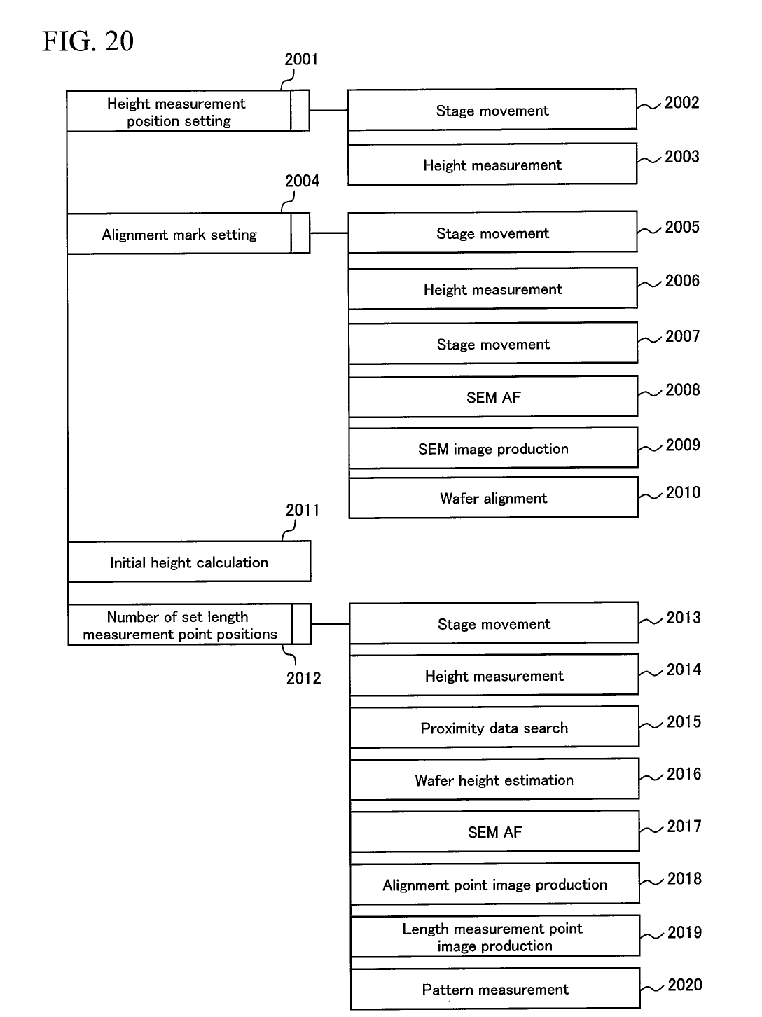

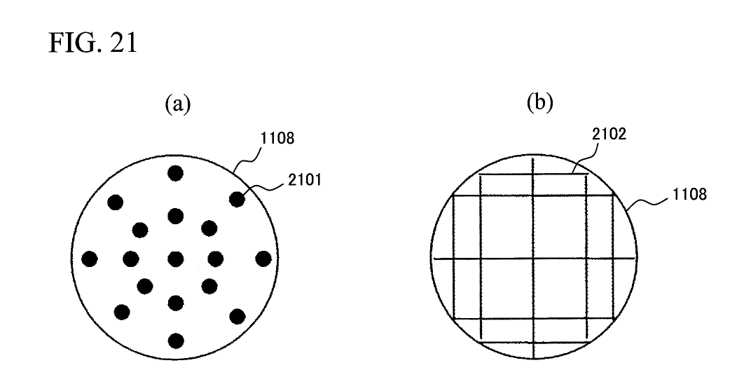

FIG. 20 is a control sequence diagram for the length measuring SEM shown as an example in which an SEM image is acquired by moving the stage on a step and repeat manner based on a small number of previous height measurement results. FIG. 21 is a plan view of the substrate 1108, showing a height measurement position.

To allow the general height distribution on the substrate 1108 to be determined, a plurality of height measurement points are proportionately set on the substrate 1108 (step 2001). For example, as shown by black circles in FIG. 21(A), to allow height measurement data to be acquired at about 17 measurement points 2101, the XY stage 1117 is moved to each of the measurement points 2101 (step 2002). Height measurement data is then acquired at the measurement point (step 2003). When the height is measured with the XY stage 1117 intermittently moved in a step and repeat manner, a longer time is required for the measurement. Thus, as shown in FIG. 21(B), a plurality of lines 2102 are set such that each of the measurement points 2101 set in FIG. 21(A) is enclosed in any of the lines. The XY stage 1117 is then continuously moved along the lines 2102, with the height measured at each of the measurement points 2101.

Then, about four of alignment marks preset on the substrate 1108 and the coordinates of which are known are selectively set (step 2004). The XY stage 1117 is moved to one of the selected alignment marks (step 2005). The height of the substrate is measured (step 2006). Subsequently, the XY stage 1117 is moved to allow an SEM image of the alignment mark to be produced (step 2007). Based on the height measurement data obtained in step 2006, the range of focusing for auto focusing (denoted by SEM AF in FIG. 20) of the SEM image is determined. Auto focusing is then performed (step 2008).

While the auto focusing is being performed, an SEM image of each of the alignment marks is produced with a focusing point position placed in focus (step 2009). The amount of the misalignment between the coordinates of the alignment mark on the substrate 1108 and those in the produced SEM image is determined. The substrate 1108 is then aligned (in FIG. 20, this operation is denoted by “wafer alignment”)(step 2010). Then, the initial height is measured (step 2011). By using the height measurement data obtained in step 2003, in which the height is measured at the measurement points 2101, shown in FIG. 21(A), and in step 2006, in which the height is measured at the alignment marks, the general distribution of the height measurement data on the substrate 1108 is calculated by quadratic function fitting. Thus, the initial value h (x, y, t0) of the height is determined. Then, with the length measuring SEM, SEM images of preset length measurement points are produced.

First, the positions of length measurement points are set (step 2012). The XY stage 117 is moved so that the position of auto focusing for the SEM image closest to each of the length measurement points aligns with the optical axis 1000 of the electronic optical system of the SEM (step 2013). The height is then measured (step 2014). Then, Expression 1 described above is used to search for the height measurement data closest to the already measured one (step 2015). Expression 2 described above is then used to estimate the value of the height of the substrate 1108 at the position of the optical axis 1000 of the SEM (step 2016). Based on the estimated value of the height of the substrate 1108, the range of the focal depth for the auto focusing of the SEM image is set. Auto focusing is then performed (step 2017). Then, within the range from the position of the finished auto focusing within which the electron beam can be polarized, a pattern for micro-alignment which desirably has a unique shape that is easy to find is set to be an alignment point. An SEM image of the alignment point is produced (step 2018). A coefficient is then determined which allows correction of the misalignment between the coordinates of the alignment point and those of the alignment mark.

Then, while the misalignment is being corrected, the visual field of the SEM is moved to the position of the pattern the length of which is to be measured. An image of the length measurement point is produced (step 2019). A pattern width, an inter-pattern distance, and the like are measured in the image obtained (step 2020). In step 2019, the length measurement point is within the range within which the electron beam can be varied. Thus, the movement of the XY stage 1117 for the shifting of the visual field is not required.

By way of example, the length measuring SEM has been described, in which the stage is moved on a step and repeat manner. However, even with the review SEM, a high-magnification image of a defect can be automatically produced according to a similar sequence by replacing the length measurement point with the coordinates of the defect output by the inspection apparatus.

### (6) Fifth Embodiment

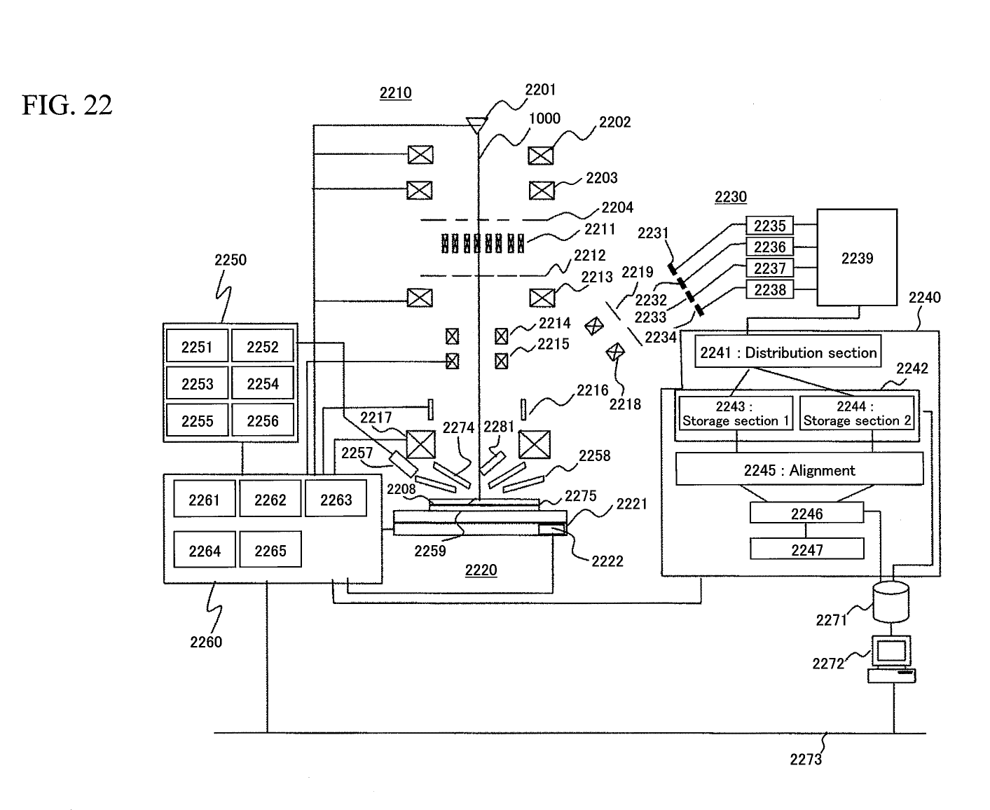

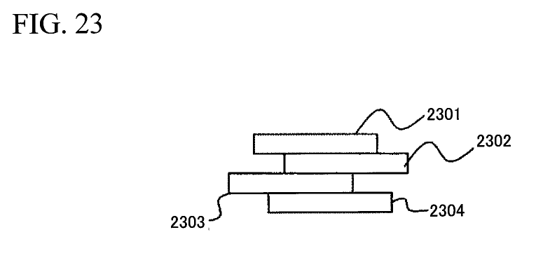

A fifth embodiment of the present invention will be described with reference to FIGS. 22 and 23. FIG. 22 is a diagram showing the configuration of an SEM apparatus according to the present embodiment. The SEM apparatus as a whole is composed of an electronic optical system 2210, a table control system 2220, a detection system 2230, an image processing system 2240, a height detecting system 2250, a control system 2260, a secondary storage device 2271, and a computer 2272. The SEM apparatus is connected to a network 2273. An electron beam generated by an electron source 2201 is applied to a substrate 2208 around an optical axis 1000. Electromagnetic lenses 2202 and 2203 set the electron beam parallel to the optical axis 1000. Apertures in a first aperture array 2204 are arranged on a two-dimensional plane divide the electron beam into a plurality of beams. For example, when the four apertures are present in each of the x direction and the y direction, the electron beams are divided into 16 beams. A lens array 2211 converges each of the resulting beams. A second aperture array 2212 inhibits the passage of electrons traveling horizontally outside each of the apertures. An electromagnetic lens 2213 converges the plurality of electron beams having passed through the apertures in the second aperture array 2212 so that the beams follow the trajectories around the optical axis 1000 and converge on the substrate 2208. The electron beams each have a small diameter and are thus polarized by an X polarizer 2214 and a Y polarizer 2215 so as to scan the substrate 2208 to obtain the image of the substrate 2208. An ExB polarizer 2216 has the function of polarizing secondary electrons generated by the irradiation of the substrate 2208 with the electron beams, toward a detector provided away from the optical axis 1000, and the function of avoiding polarizing primary electron beams passing in the direction opposite to that of the secondary electrons. An electromagnetic lens 2217 forms an image of the second aperture array 2212 on the top surface of the substrate 2208.

When the substrate 2208 is irradiated with the electron beams, secondary electrons are generated and polarized, by the ExB polarizer 2216, toward detectors 2231, 2232, 2233, and 2234 provided away from the optical axis 1000. An electromagnetic lens 2218 and an aperture 2219 are provided on the trajectory of the secondary electrons to block secondary electrons the trajectory of which deviates significantly from the direction toward the detectors 2231, 2232, 2233, and 2234. Outputs from the detectors 2231, 2232, 2233, and 2234 generated by the detection of the secondary electrons are converted from analog signals into digital signals by A/D converters 2235, 2236, 2237, and 2238. Then, an image generating section 2239 uses all outputs from the A/D converters 2235, 2236, 2237, and 2238 to generate one image. The generated image is transferred to a distribution section 2241 of the image processing system 2240. The image is then stored in a storage section (1) 2243 or (2) 2244 of the storage section 2242. In the present embodiment, a case will be described in which signals detected in at least two dies for comparison are stored in the storage section (1) 2243 as a reference image, whereas signals detected in the at least two dies for comparison are stored in the storage section (2) 2244 as an inspection image.

A substrate holder 2275 with the substrate 2208 fixed thereto is placed on an XY stage 2221. The XY stage 2221 includes a measuring section 2222 such as a laser length measuring instrument which measures the position of an X stage or a Y stage. Positional information on the XY stage 2221 measured by the measuring section 2222 is input to a polarization controlling section 2261 of the control system 2260. The polarization controlling section 2261 thus controls the X polarizer 2214 and the Y polarizer 2215 so that the electron beams are polarized in a desired direction at a desired timing. For inspection, the substrate 2208 is continuously moved in one direction, for example, the Y direction. At the same time, the electron beams are polarized, for scanning, in a direction orthogonal to the moving direction of the XY stage 2221, for example, the X direction. Thus, a two-dimensional image of the area of the substrate 2208 scanned by the electron beams can be produced. The two-dimensional image is stored in the storage section 2242 on the basis of predetermined partitioning. The polarization controlling section 2261 fine-tunes the X polarizer 2214 and the Y polarizer 2215 so that even if the stage moving speed varies during the movement of the XY stage 2221, an image with the same pixel size can be acquired. In a different mode, an image may be acquired with the XY stage 2221 remaining stationary. In this case, for example, the X polarizer 2214 allows the electron beams to scan the substrate in the X direction. The Y polarizer 2215 then allows the electron beams to move in the Y direction by a distance corresponding to the diameter of the electron beam. The X polarizer 2214 allows the electron beams to scan the substrate again. The above-described operation is repeated to allow a two-dimensional image of a given area to be acquired. An alignment section 2245 of the image processing system 2240 aligns the reference image with the inspection image as is the case with the first embodiment. A difference calculating section 2246 compares the reference image and inspection image for which the misalignment has been corrected, to calculate the difference in signal amount between the reference image and the inspection image for each pixel. FIG. 23 is a plan view schematically showing the misalignment between images acquired. Images 2301, 2302, 2303, and 2304 obtained by the detectors 2235, 2236, 2237, and 2238 are misaligned on the substrate 2208 as shown in FIG. 23. In this case, the image generating section 2239 generates one image with the misalignment of each of the images taken into account.

A large-difference area extracting section 2247 outputs, as a defect, a signal for the coordinates of a pixel for which the difference output by the difference calculating section 2246 is larger than a corresponding inspection parameter stored in the secondary storage device 2271; the signal is also indicative of the difference. If the characteristics of the image have been input to the large-difference area extracting section 2247 by the difference calculating section 2246, the defect may be determined based on the characteristics of the image. The secondary storage device 2271 is set to receive and store the image stored in any region in the storage section (1) 2243 or (2) 2244 of the storage section 2242. The secondary storage device 2271 can also store the coordinates of the defect extracted by the large-difference area extracting section 2247 and the characteristics of the image output by the difference calculating section 2246. The computer 2272 has a GUI terminal and can display, on a substrate map, an area suspected to be severely affected by an extracted process variation. The computer 2272 is also connected to a network 2273 such as an external LAN. An external apparatus can input inspection parameters to the computer 2272. The computer 2272 can output images acquired and inspection results to the external apparatus.

A light pattern image producing section 2257 of the height detecting system 2250 illuminates the surface of the substrate 2208 with a light pattern via an optical path formed in a shield electrode 2258 as is the case with the above-described third embodiment. The light pattern may be one or more line patterns, one or more point patterns, a combination of the line and point patterns, or the like as is the case with the above-described first embodiment. The light pattern is applied to the surface of the substrate 2208 at a position located away from the optical axis 1000 of the electronic optical system 2210. For example, the light pattern is applied to the substrate 2208 at a position located 15 mm away from the optical axis 1000 of the electronic optical system 2210, in a direction opposite to the moving direction of the XY stage 2221. An irradiation angle in the vertical direction is set to 80 degrees to the normal of the substrate.

The light pattern image producing section 2257 produces an image of the light pattern applied to the surface of the substrate 2208 by a light pattern projecting section 2281. A pattern storage section 2251 of the height detecting system 2250 stores the pattern the image of which has been produced by the light pattern image producing section 2257. A height calculating section 2252 calculates the height of the substrate 2208 irradiated with the light pattern as is the case with the third embodiment of the present invention. A height calculation result storage buffer 2253 stores the height of the substrate calculated by the height calculating section 2252 based on an output value from the stage position measuring section 2222 and the position 2259 of the substrate corresponding to the height measurement so that the height of the substrate is associated with the position 2259 of the substrate. Variation in the height of the substrate 2208 varies the position where the height of the light pattern applied to the surface of the substrate 2208 by the light pattern projecting section 2281 is measured. This in turn varies, in the horizontal direction, the light pattern irradiation position on the substrate 2208 the image of which is produced by the light pattern image producing section 2257. Thus, the amount of the variation is calculated to determine the position corresponding to the height measurement.

An in-plane height calculating section 2254 of the height detecting system 2250 calculates the height of the whole or a partial area of the substrate based on a plurality of height calculation results stored in the height calculation result storage buffer 2253. A storage section 2255 stores data on the in-plane height obtained by the in-plane height calculating section 2254 as is the case with the above-described third embodiment. A height data correction amount calculator 2256 corrects pre-calculated height data as is the case with the above-described third embodiment.

A focusing section 2274 of the control system 2260 has a mechanism that controls an excitation current for the objective lens 2217 in the SEM apparatus. The height calculation result storage buffer 2253 is also connected directly to the focusing section 2274. Like the storage section 2255, the height calculation result storage buffer 2253 outputs the height data on the substrate 2208 stored therein in association with the optical axis 1000 of the electronic optical system, based on output data from the stage position measuring section 2222. A sequence controlling section 2263 controls the operation of the apparatus as a whole. A stage controlling section 2264 controls the movement of the stage based on a sequence from the sequence controlling section 2263. An electronic optical system controlling section 2265 controls a beam current for the electronic optical system and thus an excitation current for the objective lens 2217 and the electromagnetic lens 2218.

### (7) Sixth Embodiment

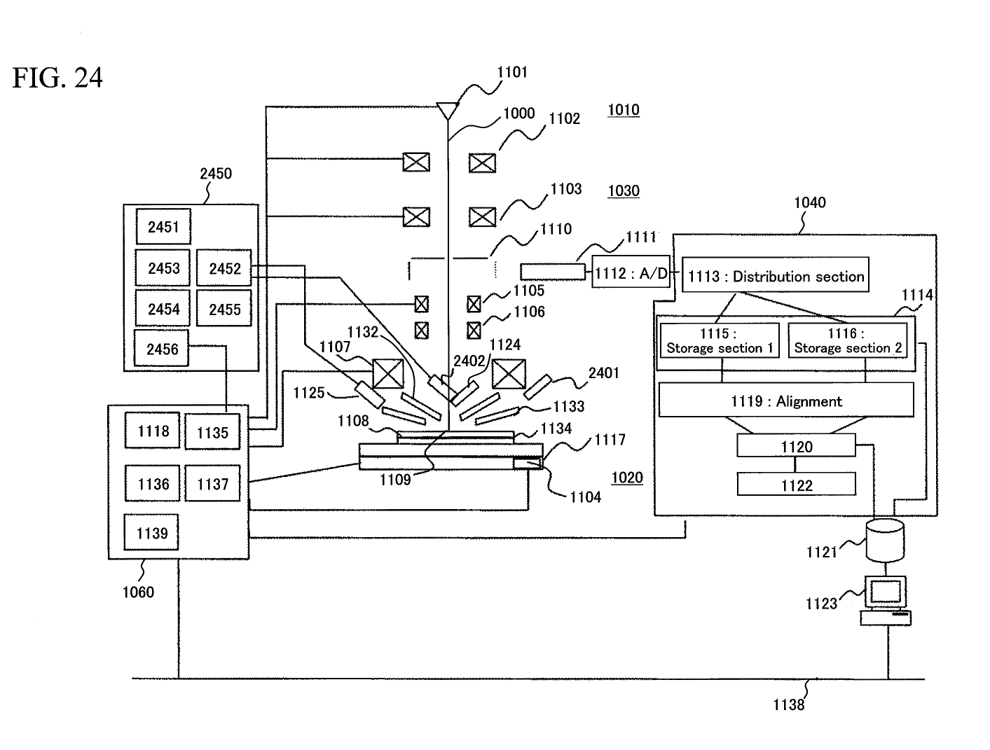

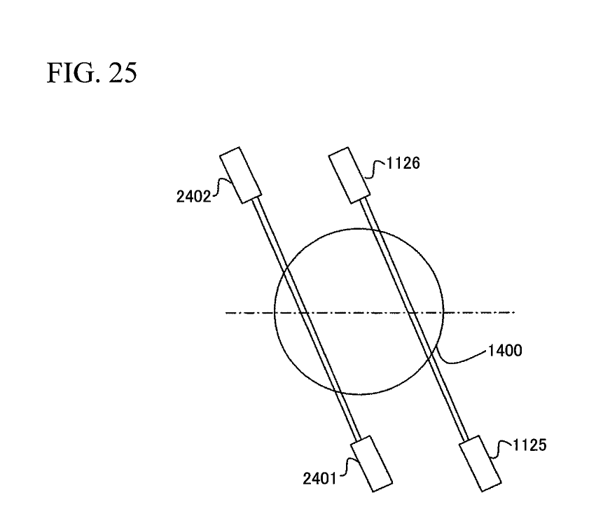

FIG. 24 is a diagram showing an embodiment in which a plurality of height measuring sections are provided in the SEM apparatus configured as shown in FIG. 10. The configuration in FIG. 24 differs from that in FIG. 10 in that the former further includes a light pattern projecting section 2401 and a light pattern image producing section 2402. In addition to the optical paths 1601 and 1602 for the light pattern projecting section 1124 and light pattern image producing section 1125 as shown in FIG. 15(B), the shield electrode 1133 includes an optical path through which illumination light from the light pattern projecting section 2401 and an optical path through which reflected light is passed to the light pattern image producing section 2402, though the optical paths are not shown in the drawings. FIG. 25 is a plan view of the SEM column 1400 showing the arrangement of the light pattern projecting sections 1124 and 2401 and the light pattern image producing sections 1125 and 2402 as viewed from above. The light pattern can be applied to the right and left sides of the optical axis of the electronic optical system in the X direction. From whichever direction the stage is moved, the height of the position where the SEM apparatus produces an image can be pre-measured. A pattern storage section 2451 of a height detecting system 2450 stores an image of the light pattern applied to the surface of the substrate 1108, the image having been produced by the light pattern image producing sections 1125 and 2401. A height calculating section 2452 processes the image stored in the pattern storage section 2451 to determine the position of the line or point pattern applied to the substrate 1108. Then, based on the position obtained, the height calculating section 2452 calculates the height using the principle of triangulation. A height calculation result storage buffer 2453 stores the height of the substrate calculated by the height calculating section 2452 based on the output value from the stage position measuring section 1104 and the position of the substrate corresponding to the height measurement so that the height of the substrate is associated with the position of the substrate. The height calculation result storage buffer 2452 has two modes, that is, a mode in which both outputs from the light pattern image producing sections 2402 and 1125 are stored and a mode in which an average value for the height measurement data from the light pattern image producing sections 2402 and 1125 is stored as height measurement data obtained at a central position between the height measurement positions of the light pattern image producing sections 2402 and 1125, that is, almost at the position of the optical axis. The height calculation result storage buffer 2452 can use any one of the two modes as required. If for one of the outputs from the light pattern image producing sections 2402 and 1125, the height measurement position is outside of the substrate 1108, resulting in a failure in height measurement, then only the height measurement data obtained inside the substrate 1108 is stored.

In the above-described embodiments, the optical height detecting technique is used to measure the height of the substrate 1108 by way of example. However, the effects of the present invention can also be exerted by using a non-optical technique such as an electrostatic capacitance type as a height measuring technique. Thus, the height detecting technique according to the present invention is not limited to the optical type described above in the embodiments. Furthermore, the effects of the present invention can also be exerted by replacing one of the two optical height detecting techniques described in the sixth embodiment, with the non-optical technique such as an electrostatic capacitance type.

The present invention will be summarized below.

(1) An apparatus for inspecting a substrate, the apparatus indicating the substrate with an electron beam to inspect the substrate for a defect based on an image produced based on a secondary electron or a reflected electron generated on the substrate, the apparatus comprising:

a height measurement section which measures height of the electron beam irradiation position on the substrate after the substrate is loaded onto a movable stage;

a height correction processing section which corrects the measured height; and

a control section which adjusts a focus of the electron beam according to the height corrected by the height correction processing section,

wherein a stage position set when the height measurement section measures the height differs from a stage position set when the substrate is irradiated with the electron beam, and

the height correction processing section corrects a possible deviation in height resulting from movement from the stage position for the height measurement to the stage position for the electron beam irradiation.

(2) The apparatus for inspecting the substrate according to claim 1, further comprising:

a charging control electrode located in a vicinity of the substrate position for the electron beam irradiation to control charging of the substrate.

(3) The apparatus for inspecting the substrate according to claim 1, wherein the height correction processing section executes the height correction as an online process during the substrate defect inspection or substrate image acquisition.

(4) The apparatus for inspecting the substrate according to claim 1, wherein the height correction processing section executes the height correction as an offline process at a timing different from that for the substrate defect inspection or substrate image acquisition.

(5) The apparatus for inspecting the substrate according to claim 4, further comprising:

a correction data storage section which stores correction data required for the stage movement from the stage position for the height measurement to the stage position for the electron beam irradiation,

wherein the height correction processing section corrects the measured height based on the correction data stored in the correction data storage section.

(6) The apparatus for inspecting the substrate according to claim 5, further comprising:

a display section which displays the correction data on a screen.

(7) The apparatus for inspecting the substrate according to claim 1, wherein the defect inspection of the substrate is executed by continuously moving the stage, and

the height correction processing section executes the height correction every time the stage is moved.

(8) The apparatus for inspecting the substrate according to claim 1, wherein a deviation in height resulting from the movement from the stage position for the height measurement to the stage position for the electron beam irradiation is caused by inclination of the stage.

(9) The apparatus for inspecting the substrate according to claim 1, wherein the height measurement section measures the height of the substrate using a combination of a reflected light-type measuring instrument or a laser interferometer-type shape measuring instrument and an electrostatic capacitance-type displacement meter.

(10) A method of inspecting a substrate, the method using a substrate inspecting apparatus to irradiate the substrate with an electron beam to inspect the substrate for a defect based on an image produced based on a secondary electron or a reflected electron generated on the substrate, the method comprising the steps of:

allowing a height measurement section to measure height of the electron beam irradiation position on the substrate after the substrate is loaded onto a movable stage;

allowing a height correction processing section to correct the measured height; and

allowing a control section to adjust a focus of the electron beam according to the height corrected in the correcting step of the height correction processing section,

wherein a stage position set when the height measurement section measures the height differs from a stage position set when the substrate is irradiated with the electron beam, and

the height correction processing section corrects a possible deviation in height resulting from movement from the stage position for the height measurement to the stage position for the electron beam irradiation.

(11) The method of inspecting the substrate according to claim 10, wherein the substrate inspecting apparatus comprises a charging control electrode located in a vicinity of the substrate position for the electron beam irradiation to control charging of the substrate.

(12) The method of inspecting the substrate according to claim 10, wherein in the height correcting step, the height correction processing section executes the height correction as an online process during the substrate defect inspection or substrate image acquisition.

(13) The method of inspecting the substrate according to claim 10, wherein in the height correcting step, the height correction processing section executes the height correction as an offline process at a timing different from that for the substrate defect inspection or substrate image acquisition.

(14) The method of inspecting the substrate according to claim 13, wherein the substrate inspecting apparatus comprises a correction data storage section which stores correction data required for the stage movement from the stage position for the height measurement to the stage position for the electron beam irradiation, and

in the height correcting step, the height correction processing section corrects the measured height based on the correction data stored in the correction data storage section.

(15) The method of inspecting the substrate according to claim 14, wherein a display section comprises a correction data display step of displaying the correction data on a screen.

(16) The method of inspecting the substrate according to claim 10, wherein the defect inspection of the substrate is executed by continuously moving the stage, and

in the height correcting step, the height correction processing section executes the height measurement every time the stage is moved.

(17) The method of inspecting the substrate according to claim 10, wherein a deviation in height resulting from the movement from the stage position for the height measurement to the stage position for the electron beam irradiation is caused by inclination of the stage.

(18) The method of inspecting the substrate according to claim 10, wherein in the height measuring step, the height measurement section measures the height of the substrate using a combination of a reflected light-type measuring instrument or a laser interferometer-type shape measuring instrument and an electrostatic capacitance-type displacement meter.

(19) A scanning electron microscope comprising:

a table system which is movable in a plane with a substrate placed thereon;

an electronic optical system having an electron gun which emits a primary electron beam, an electron lens section which converges the primary electron beam emitted by the electron gun, and a beam polarizer which polarizes the primary electron beam focused by the electron lens section and irradiates a surface of the substrate placed on the table system with the primary electron beam for scanning;

a secondary electron detecting system which detects a secondary electron or a reflected electron generated on the substrate irradiated with the primary electron beam by the electronic optical system and scanned by the primary electron beam;

an A/D converter which digitalizes a signal obtained by detecting the secondary electron or reflected electron generated on the substrate by the secondary electron detecting system;

image storage unit to which the signal digitalized by the A/D converter is input and stored as a digital image;

an image processing system which processes the digital image stored in the image storage unit; and

a height detection control system which detects height of the surface of the substrate placed on the table system to control a focus position of the electron lens in the electronic control system,

wherein the height detection control system comprises:

a height detecting section which detects height of a position on the surface of the substrate placed on the table system which position is located away from an electron beam optical axis of the electronic optical system,

a substrate height estimating section which estimates the height of the surface of the substrate at a portion on the electron beam optical axis of the electronic optical system using information on the height of the position on the surface of the substrate located away from the electron beam optical axis, the height being detected by the height detecting section, and

a focus position adjusting section which adjusts a focus position of the primary electron beam by controlling the electron lens section of the electronic optical system based on the information on the height of the substrate at the portion on the electron beam optical axis of the electronic optical system estimated by the substrate height estimating section.

(20) The scanning electron microscope according to claim 19, further comprising:

a surface field control electrode located between the electron lens section of the electronic optical system and the table system to enable an electric field between the surface field control electrode and the table system to be varied,

wherein the surface field control electrode has, in a central portion, an opening through which the primary electron, the secondary electron, and the reflected electron are passed, and the surface field control electrode has a small distance, in a vicinity of the opening, from a surface of the table system on which the substrate is placed and has a large distance, at a portion located away from the central portion, from the surface of the table system on which the substrate is placed, and the surface field control electrode has a rotationally symmetric shape.

(21) The scanning electron microscope according to claim 19, further comprising:

a shield electrode provided outside the electron beam optical axis with respect to the surface field control electrode and configured to be set to a potential equal to that of the substrate placed on the table system; and

an opening formed to allow the height detecting section to detect the height of the position located away from the electron beam optical axis, the opening being formed asymmetric with respect to the electron beam optical axis.

(22) The scanning electron microscope according to claim 19, wherein the height detecting section of the height detection control system further comprises:

a light pattern illuminating section which projects a light pattern on the surface of the substrate placed on the table system, at a position located away from the electron beam optical axis of the electronic optical system;

a light pattern image production section which produces an image of the light pattern projected on the surface of the substrate, from a direction different from that in which the light pattern is projected; and

a height calculation section which calculates the height of the position on the surface of the substrate where the pattern is projected, using information on the image of the light pattern projected on the surface of the substrate, the image being produced by the light pattern image production section.

(23) The scanning electron microscope according to claim 22, wherein the height estimating section of the height detection controlling section further comprises:

a height information storage section which stores the height information on the position on the surface of the substrate where the light pattern is projected, the height information being detected by the height detecting section; and

a substrate height calculation section which calculates the height of the substrate at the portion on the electron beam optical axis of the electronic optical system based on the height data on the position on the surface of the substrate where the light pattern is projected, the height data being output by the height detecting section, and the height data stored in the height information storage section.

(24) The scanning electron microscope according to claim 22, wherein the table system comprises a position detecting section which detects the position of the substrate placed on the table system, and

the height information storage section of the substrate height estimating section of the height detection control system stores the height information on the position on the surface of the substrate where the light pattern is projected, the height information being detected by the height detecting section, in association with the positional information on the substrate detected by the position detecting section.

(25) The scanning electron microscope according to claim 24, wherein the height information storage section stores the height information on the position on the surface of the substrate where the light pattern is projected, the height information being acquired for the same position on the substrate at different timings.

(26) The scanning electron microscope according to claim 22, wherein the table system comprises a rotatable rotating table and a rotation angle control section which controls rotation angle of the rotating table,

the light pattern illuminating section projects, as the light pattern, slit light on the surface of the substrate at the position located away from the electron beam optical axis of the electronic optical system, and

the rotation angle control section controls the rotation angle of the substrate so that the slit light projected on the substrate crosses the pattern formed on the substrate.

(27) The scanning electron microscope according to claim 22, wherein the height detection control system comprises plural sets each of the light pattern illuminating section and the light pattern image production section, and the plural sets each of the light pattern illuminating section and the light pattern image production section each measure the height of the position on the surface of the substrate which position is located away from the electron beam optical axis of the electronic optical system.

(28) A method of producing an image of a substrate using a scanning electron microscope, the method comprising the steps of:

irradiating the substrate placed on a table which is movable in a plane, with an electron beam focused via an electron lens section of an electronic optical system of the scanning electron microscope, for scanning;

detecting a secondary electron or a reflected electron generated on the substrate irradiated with and scanned by the focused electron beam; and

obtaining a digital image of the substrate by subjecting a signal resulting from the detection to A/D conversion,

wherein the step of obtaining the digital image of the substrate further comprises the steps of:

detecting height of a position on the surface of the substrate placed on the table which position is located away from an electron beam optical axis of the electronic optical system;

estimating the height of the surface of the substrate at a portion on the electron beam optical axis using information on the detected height of the position on the surface of the substrate located away from the electron beam optical axis;

adjusting a focus position of the electron beam applied to the substrate by controlling the electron lens section of the electronic optical system based on the information on the estimated height of the substrate at the portion on the electron beam optical axis; and

obtaining a digital image of the substrate from a signal resulting from detection of a secondary electron or a reflected electron generated on the substrate by irradiating the substrate with the electron beam with the focus position adjusted, for scanning.

(29) The method of producing the image of the substrate using the scanning electron microscope according to claim 28, wherein the step of obtaining the digital image of the substrate further comprises the steps of:

projecting a light pattern on the surface of the substrate at a position located away from the electron beam optical axis of the electronic optical system;

producing an image of the light pattern projected on the surface of the substrate, from a direction different from that in which the light pattern is projected; and

calculating the height of the position on the surface of the substrate where the light pattern is projected, using information on the image of the light pattern projected on the surface of the substrate, the information being obtained by the image production.

(30) The method of producing the image of the substrate using the scanning electron microscope according to claim 29, wherein as the light pattern, slit light is projected on the surface of the substrate at the position located away from the electron beam optical axis of the electronic optical system so that the slit light crosses a pattern formed on the substrate.

(31) The method of producing the image of the substrate using the scanning electron microscope according to claim 29, wherein the light pattern projected at the position located away from the electron beam optical axis of the electronic optical system is slit light.

(32) The method of producing the image of the substrate using the scanning electron microscope according to claim 31, wherein the detected height information on the position on the surface of the substrate where the light pattern is projected is stored in association with positional information on the substrate placed on the table.

(33) The method of producing the image of the substrate using the scanning electron microscope according to claim 31, wherein height information on the position on the surface of the substrate where the light pattern is projected is stored such that the height information is acquired for the same position on the substrate at different timings.

(34) The method of producing the image of the substrate using the scanning electron microscope according to claim 28, wherein the step of obtaining the digital image of the substrate further comprises the steps of:

storing the detected height information on the position on the surface of the substrate where the light pattern is projected; and

calculating the height of the substrate at a portion on the electron beam optical axis based on the detected height data on the position on the surface of the substrate where the light pattern is projected and the stored height data.

What is claimed is:

1. An apparatus for inspecting a substrate, the apparatus indicating the substrate with an electron beam to inspect the substrate for a defect based on an image produced based on a secondary electron or a reflected electron generated on the substrate, the apparatus comprising:
a height measurement section which measures height of the electron beam irradiation position on the substrate after the substrate is loaded onto a movable stage;
a height correction processing section which corrects the measured height; and
a control section which adjusts a focus of the electron beam according to the height corrected by the height correction processing section,
wherein a stage position set when the height measurement section measures the height differs from a stage position set when the substrate is irradiated with the electron beam, and
the height correction processing section corrects a possible deviation in height resulting from movement from the stage position for the height measurement to the stage position for the electron beam irradiation.

2. The apparatus for inspecting the substrate according to claim 1, further comprising:
a charging control electrode located in a vicinity of the substrate position for the electron beam irradiation to control charging of the substrate.

3. The apparatus for inspecting the substrate according to claim 1, wherein the height correction processing section executes the height correction as an online process during the substrate defect inspection or substrate image acquisition.

4. The apparatus for inspecting the substrate according to claim 1, wherein the height correction processing section executes the height correction as an offline process at a timing different from that for the substrate defect inspection or substrate image acquisition.

5. The apparatus for inspecting the substrate according to claim 4, further comprising:
a correction data storage section which stores correction data required for the stage movement from the stage position for the height measurement to the stage position for the electron beam irradiation,
wherein the height correction processing section corrects the measured height based on the correction data stored in the correction data storage section.

6. The apparatus for inspecting the substrate according to claim 5, further comprising:
a display section which displays the correction data on a screen.

7. The apparatus for inspecting the substrate according to claim 1, wherein the defect inspection of the substrate is executed by continuously moving the stage, and
the height correction processing section executes the height correction every time the stage is moved.

8. The apparatus for inspecting the substrate according to claim 1, wherein a deviation in height resulting from the movement from the stage position for the height measurement to the stage position for the electron beam irradiation is caused by inclination of the stage.

9. The apparatus for inspecting the substrate according to claim 1, wherein the height measurement section measures the height of the substrate using a combination of a reflected light-type measuring instrument or a laser interferometer-type shape measuring instrument and an electrostatic capacitance-type displacement meter.

10. A method of inspecting a substrate, the method using a substrate inspecting apparatus to irradiate the substrate with an electron beam to inspect the substrate for a defect based on an image produced based on a secondary electron or a reflected electron generated on the substrate, the method comprising the steps of:
allowing a height measurement section to measure height of the electron beam irradiation position on the substrate after the substrate is loaded onto a movable stage;
allowing a height correction processing section to correct the measured height; and
allowing a control section to adjust a focus of the electron beam according to the height corrected in the correcting step of the height correction processing section,
wherein a stage position set when the height measurement section measures the height differs from a stage position set when the substrate is irradiated with the electron beam, and
the height correction processing section corrects a possible deviation in height resulting from movement from the stage position for the height measurement to the stage position for the electron beam irradiation.

11. The method of inspecting the substrate according to claim 10, wherein the substrate inspecting apparatus comprises a charging control electrode located in a vicinity of the substrate position for the electron beam irradiation to control charging of the substrate.

12. The method of inspecting the substrate according to claim 10, wherein in the height correcting step, the height correction processing section executes the height correction as an online process during the substrate defect inspection or substrate image acquisition.

13. The method of inspecting the substrate according to claim 10, wherein in the height correcting step, the height correction processing section executes the height correction as an offline process at a timing different from that for the substrate defect inspection or substrate image acquisition.

14. The method of inspecting the substrate according to claim 13, wherein the substrate inspecting apparatus comprises a correction data storage section which stores correction data required for the stage movement from the stage position for the height measurement to the stage position for the electron beam irradiation, and
in the height correcting step, the height correction processing section corrects the measured height based on the correction data stored in the correction data storage section.

15. The method of inspecting the substrate according to claim 14, wherein a display section comprises a correction data display step of displaying the correction data on a screen.

16. The method of inspecting the substrate according to claim 10, wherein the defect inspection of the substrate is executed by continuously moving the stage, and
in the height correcting step, the height correction processing section executes the height measurement every time the stage is moved.

17. The method of inspecting the substrate according to claim 10, wherein a deviation in height resulting from the movement from the stage position for the height measurement to the stage position for the electron beam irradiation is caused by inclination of the stage.

18. The method of inspecting the substrate according to claim 10, wherein in the height measuring step, the height measurement section measures the height of the substrate using a combination of a reflected light-type measuring instrument or a laser interferometer-type shape measuring instrument and an electrostatic capacitance-type displacement meter.
